(19) United States
(12) Patent Application Publication
(10) Pub. No.: US 2005/0216313 A1
(43) Pub. Date: Sep. 29, 2005

(54) Method, device, and systems to facilitate identity management and bidirectional data flow within a patient electronic record keeping system

(75) Inventors: Robert Daniel Claud, Chicago, IL (US); Erika Chiong Claud, Chicago, IL (US)

Correspondence Address: BANNER & WITCOFF, LTD., TEN SOUTH WACKER DRIVE, SUITE 3000, CHICAGO, IL, 60606, US

(73) Assignee: eCapable, Inc., Chicago, IL (US)

(21) Appl. No.: 11/089,400

(22) Filed: Mar. 24, 2005

Related U.S. Application Data
(60) Provisional application No. 60/556,470, filed on Mar. 26, 2004.
(60) Provisional application No. 60/577,855, filed on Jun. 8, 2004.
(60) Provisional application No. 60/578,189, filed on Jun. 9, 2004.
(60) Provisional application No. 60/598,470, filed on Aug. 3, 2004.
(60) Provisional application No. 60/609,973, filed on Sep. 15, 2004.
(60) Provisional application No. 60/624,516, filed on Nov. 3, 2004.

(51) Int. Cl. G06F 17/60

(52) U.S. Cl. 705/3; 705/2

(57) ABSTRACT

A electronic medical record keeping system includes a central data collection and data storage server linked via a network to different health data input sources each of which provides controlled unidirectional input data via a first encryption key code for individual patients thereby enabling assimilation of data in the central server uniquely for each patient segregated from all other patient data, and which further includes a second encryption key code for the patient correlated with the first key code to enable (1) initiation of a set of tool bar screens at a terminal accessed by the patient (or doctor if authorized) and (2) bidirectional network connection to the unique patient data stored in the remote server.

### CROSS-REFERENCE TO RELATED APPLICATIONS

This is a utility application based upon incorporating by reference and claiming priority to the following provisional applications:

| No. | Ser. No. | Filing Date | Title |
|---|---|---|---|
| 1. | 60/556,470 | Mar. 26, 2004 | Methods and System for Health |
| | | | Care Consumer Empowerment |
| | | | Through Medical Records Storage |
| | | | and Retrieval |
| 2. | 60/577,855 | Jun. 08, 2004 | Application, Methods and System |
| | | | for Identity Verification and |
| | | | Access Control |
| 3. | 60/578,189 | Jun. 09, 2004 | Browser Based Methods and |
| | | | System for Identity Management |
| 4. | 60/598,470 | Aug. 03, 2004 | Method and System for Creating |
| | | | a Personal Digital Key with |
| | | | Ubiquitous Convenient Access |
| | | | Characteristics |
| 5. | 60/609,973 | Sep. 15, 2004 | Methods and System for “One |
| | | | Click Check In” with a Health |
| | | | Care Provider that Allows |
| | | | Bidirectional Information Flow |
| | | | at Time of Check In |
| 6. | 60/624,516 | Nov. 03, 2004 | Method, Device, and System to |
| | | | Facilitate Identity Management and |
| | | | Bidirectional Data Flow within a |
| | | | Healthcare Environment |
| 7. | | Feb. 25, 2005 | Method and System to Facilitate |
| | | | Decision Point Information Flow |
| | | | or to Improve Compliance with a |
| | | | Given Standardized Vocabulary |

### BACKGROUND OF THE INVENTION

In a principal aspect the present invention relates generally to the field of electronic medical records (EMR), and more particularly to a system that facilitates creation and use of a collection of electronic medical or patient records which reside in previously non-interoperable systems. Specifically, the invention relates to the creation of a comprehensive and complete longitudinal record of personal health information on a patient by patient basis and provides the capability for the patient and authorized users to access, retrieve, interact with and contribute to such a record. This system accomplishes this in a manner that enables rapid retrieval of key elements of a patient's personal health information while also enabling retrieval of focused historical data and further providing enhanced security for the information.

Systems have been proposed which allow the storage and retrieval of an electronic personal health record stored on a flash memory device, but these systems have drawbacks. For example, if the memory device is lost, it is inconvenient or impossible to retrieve the information. In addition, the administration of the totality of the data contained within such a system is difficult since there is no single point of access to data that is dispersed from various devices and sources.

Other systems by which a patient's personal health information is stored and retrieved exist. Their design, however, creates multiple silos of information—that is, information which is typically not interconnected or networked. This results in redundant efforts of information gathering, since the information gathered at one health care facility or source is functionally invisible to a healthcare provider or source at a different healthcare facility unconnected to the first. One disadvantage of such a system is the inability of patient service providers to perform historic record review and conduct peer to peer analysis of data. The ability to conduct long term analytical research is also thwarted.

This lack of a single, integrated repository of all health records relating to a patient is very relevant. That is, the average Medicare recipient is reported to see 6.2 physicians per year. This illustrates the difficulty a patient would encounter in trying to provide any given physician complete access to previously gathered personal health information, whether such personal health information consisted of lab tests, medications, allergies, prior medical procedures, or other relevant health care information. Consequently, redundant information is typically generated for any given medical patient. Unfortunately, the costs associated with the redundancies in information gathering, that are an inherent part of the current medical system, are staggering. Overriding the practical implications of duplicative creation of medical information is the fact that an individual's right to copies of his or her medical information has been mandated by federal law. Thus, the law tends to incentivize dispersal of redundant or potentially redundant information, again a costly event or series of events.

While many internet-based solutions for storing personal health information exist, few have achieved widespread, broad-based adoption. This may be because the potential user or patient has security concerns.

Also, while many different electronic medical record systems exist, few of them are interoperable. Interoperability amongst electronic medical record systems is clearly desirable and has current advocates within the U.S. Federal Government, see The Value of Health Care Information Exchange and Interoperability, Health Affairs, The Policy Journal of Health Sphere, Jan. 19, 2005; Walker et al.

In order to achieve interoperability between electronic medical systems, compliance with a standardized medical vocabulary is important if not essential, and, similarly, user compliance in data entry consistent with the intent of the database designer or administrator (“clean data”) is vital. “Clean data,” is generally defined as data which complies with the intent of the database designer or administrator, and “dirty data” is data which does not comply with the intent of the database designer or administrator. The problem of dirty data has been a nearly insurmountable barrier to operability between disparate record-keeping systems.

It is also clearly desirable for the user of a storage and retrieval system for personal health information to be able to retrieve emergency information; that is, information necessary for the proper care of the individual in an emergency setting.

The issue of identity management also plagues many modern databases. Put concisely, there are many people with the same name, potentially born on the same date, and there are many issues associated with data entry (mistyping, misspelling, etc). These issues create significant problems of identity management—that is, correctly associating information with the person it pertains to, without duplicate entries into the database for any given person.

These concerns are all relevant in any effort to design and implement an efficient, universal health record system which:
1) protects patient privacy;
2) adequately controls access to records by authorized persons only;
3) assimilates records from multiple and disparate sources;
4) enables appropriate editing of redundant and non-essential information;
5) provides record searching techniques which reduce the time to obtain relevant, yet complete record information;
6) provides consistency or standardization in the creation of the medical records;
7) permits emergency access to patient information;
8) enables medical research through multiple records in a manner which protects the identity of patients by rendering the record data appropriately anonymous; and
9) is cost effective;
10) improves personalization of health care; and
11) improves communications between healthcare providers for purposes of peer review, historic analysis and research.

### SUMMARY OF THE INVENTION

Briefly, the present invention provides solutions to the problems outlined above, and others. It facilitates the creation and maintenance of a longitudinal record of personal health information, and, simultaneously, the creation and maintenance of an overview of the key elements required for any health care provider to initiate and continue to provide care for a patient. By design, extremely strong security measures are preferably incorporated into the system, far stronger than those associated with typical systems which control access to information with username and password only. Identity management is achieved by a combination of features including the use of encrypted hardware keys that employ an encryption code wherein no two users are assigned identical hardware encryption key codes. A unique hardware encryption key code can be stored and retrieved on any device that is used to store and retrieve digital information, including but not limited to CD-R's, USB drives, and RFID devices.

The present invention also dictates a natural migration pathway from non-standardized vocabularies to standardized vocabularies for medical record reporting, in an extremely user-friendly, intuitive manner. Reference information that is extremely context-sensitive can be instantly displayed to the user and thereby incorporated into any decisions the user may be making at the time of data entry. The system also allows retrieval of information necessary for the care of a patient in an emergency situation, even if the patient does not have the access means normally required for access to relevant information.

A first aspect of the present invention involves identity management—the correct association of a patient's electronic medical information with the patient. This is accomplished by issuing each patient or system beneficiary an encryption key, coded preferably with not less than 768 bits, which is unique within the system. This encryption key code, in the preferred embodiment of the invention, is submitted through a network to a server and controls access to the information, along with a username and password entered by the patient at a key terminal. The server then allows access to information associated with this username, password, and encryption key combination, if such information exists; or creates a new association to information which is prospectively stored respective to the username, password, and encryption key combination. In the preferred embodiment the access information and general information formed for retrieving this unique information is encoded and stored on a flash memory device for downloading to a terminal; alternatively, a page or screen and software associated with the standard directory of information available to a patient is encoded at the terminal site. To achieve high speed access, the encryption key which is uniquely coded for each patient can also be an RFID device, and the RFID device can interact through a terminal web page or browser toolbar which allows for the submission of the username, password, and encryption key code combination. The code for a web page that automatically launches itself upon device insertion into a computer can also be placed on a USB device, CD-R device, or on other future embodiments of digital storage and retrieval.

A second aspect of the invention involves methods of storing and retrieving personal electronic health information on a server that is accessible over a network.

A third aspect of the invention involves the configuration of the flash memory device (or CD-R or other method of digital storage and retrieval) to auto launch a web page, taking advantage of the ubiquitous nature of internet browsers on computers.

A fourth aspect of the invention involves the implementation of extremely strong encryption—through the use of an encryption key, unique to each discrete user, patient or beneficiary within the system, that consists of at least 768 bits. This feature helps alleviate security concerns users may encounter when contemplating the storage and retrieval of their personal health information on a server that is connected to a network. USB (Universal Serial Bus) flash disk technology is disclosed in U.S. Pat. No. 6,148,354 by Ban, et al. When the appropriate coding, e.g. html coding, for a web page is stored on such a USB drive, the web page can launch itself upon the insertion of the USB drive into the computer. This feature, combined with the extremely long encryption key code that is unique to each hardware key device in the current invention, enables an extremely secure method of achieving identity management (correctly associating information with the person it pertains to), and storing and retrieving information.

A fifth aspect of the invention involves the establishment of interfaces with other repositories of personal health information. In one embodiment of the present invention, a browser tool bar is used to facilitate unidirectional and/or the bidirectional flow of selected information between the unique, longitudinal personal health record created according to the current invention and other sources of personal health information.

A sixth aspect of the invention involves the ability to do research relating to medicine and medical care by accessing the personal health information of those who designate their willingness to participate in such research, but also desire to remain anonymous. Such research would not be facilitated by the storage of the information on a USB drive that was carried around by individual users.

A seventh aspect of the invention involves the availability of healthcare information references which are specifically tailored to the user—via reference to the personal health information stored within the system. This includes but is not limited to information on specific medications, on specific conditions, and on specific regimens which might be appropriate for conditions that are specific to the patient/user. Additionally, legal determinations or instructions can be included in the patient record such as a living will, organ donation instructions, contact information, insurance information etc.

An eighth aspect of the invention involves the use of the system as described above in conjunction with a USB device upon which appropriate circuitry to create a virtual private network connection to a server has been placed.

A ninth aspect is to create “clean data” from “dirty data” over time. This is accomplished by allowing the user or users to manage the information that is shown in the summary view—and forcing all new or edited entries into this information set to conform to a standardized vocabulary, e.g. by means of a “drop box” that confines choices to a standardized vocabulary.

A tenth aspect of the invention is to create an “autointerpreter” that allows an individual user to bidirectionally communicate with another repository of information using an interface that allows such communication to correctly occur—such interface being automatically selected by the “autointerpreter” algorithm and therefore not necessitating human intervention for the selection of the appropriate interface algorithm.

An eleventh aspect of the invention takes advantage of the “clean data” created using the system: the clean data is machine readable/interpretable; this feature facilitates the instant or near-instant retrieval and display of context-sensitive information that is pertinent to the user-entered information.

A twelfth aspect of the invention comprises the inclusion within a USB-drive of an RFID device, which may be associated with an USB drive, and which, in conjunction with an RFID reader connected appropriately to the computer, can read the encryption key code or unique identifying number from the user's device more rapidly thereby avoiding time delay in access to the relevant records, and which will allow access to a health record system via a file or files encoded on the USB drive in the event that the user does not have access to an RFID reader.

A thirteenth aspect of the invention involves the use of the system as described above in conjunction with a USB device upon which appropriate circuitry and/or hardware is installed to facilitate biometric authentication of the user.

These and other objects, advantages, features and aspects of the invention are set forth in the detailed description which follows.

### DETAILED DESCRIPTION OF THE DRAWINGS

In the detailed description which follows, reference will be made to the drawing comprised of the following figures:

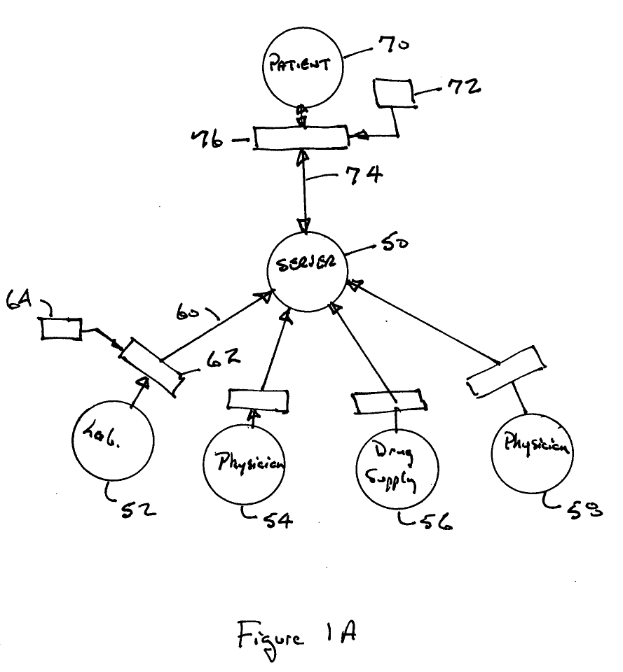

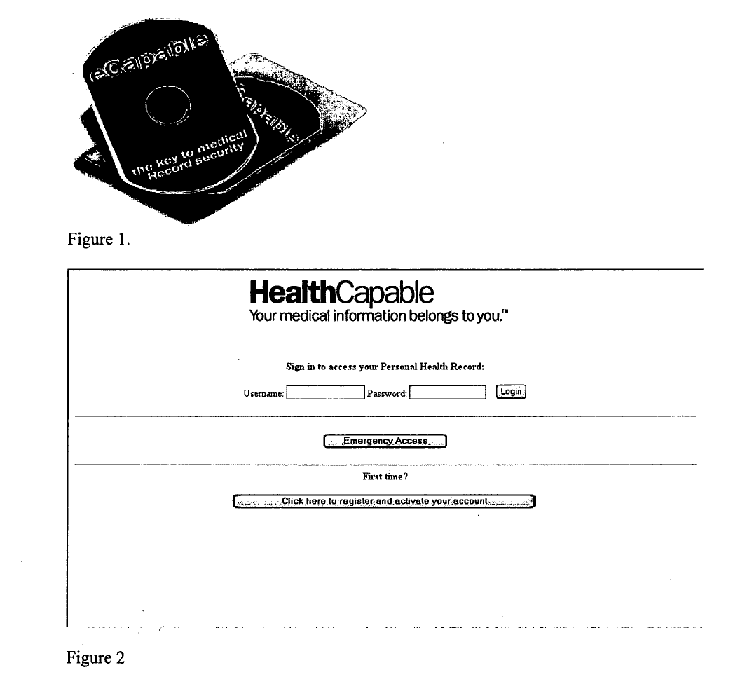

FIG. 1A is a flow diagram representative of an overview of the invention;

FIG. 1 is a is a perspective view of a CD-R according to the present invention;

FIG. 2 is a screen capture of one possible representation of the initial web page encoded on the CD-R or USB drive and issued to each user, according to the present invention;

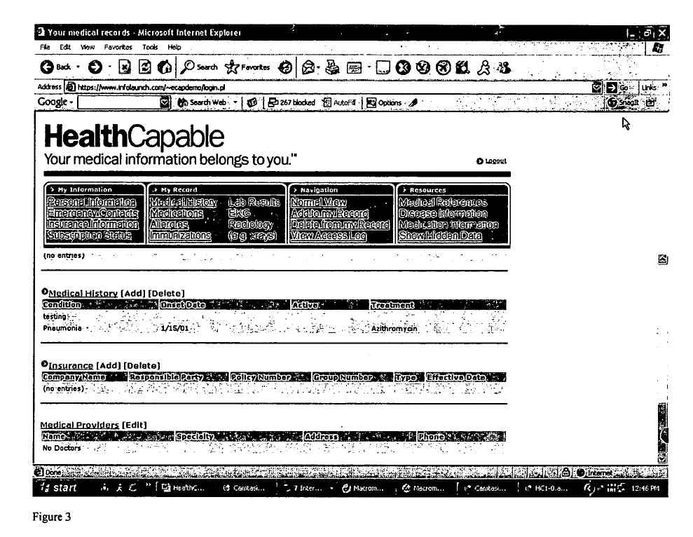

FIG. 3 is screen of one possible representation the PHI information display, according to the present invention;

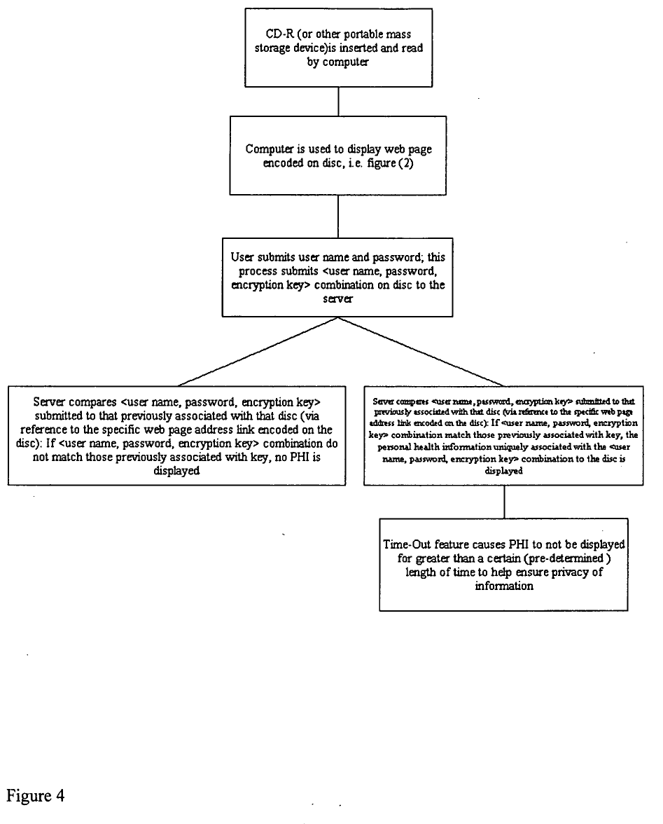

FIG. 4 is a flow chart illustrative of the process by which a user's identification is verified, and PHI is revealed to legitimate users of the system, according to the present invention;

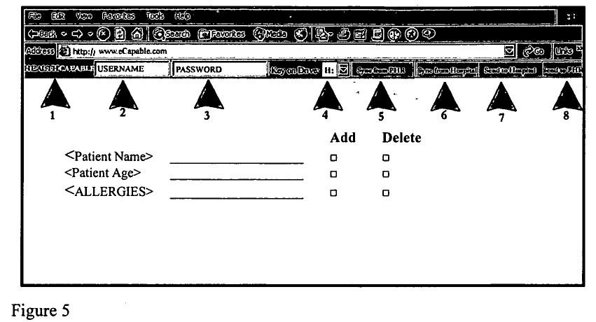

FIG. 5 is representative of a sample user interface screen that would allow the user to choose information to be added to the health care provider's electronic health record, to be added to the patient's personal health record, or be likewise deleted from either;

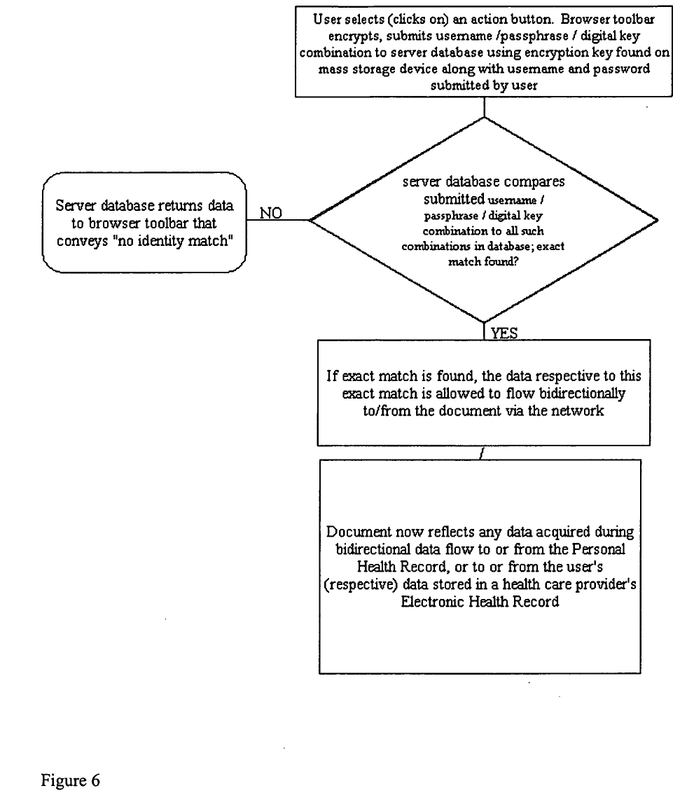

FIG. 6 is a flow chart illustrative of the process associated with the use of an action button, if the action button is located on a browser toolbar;

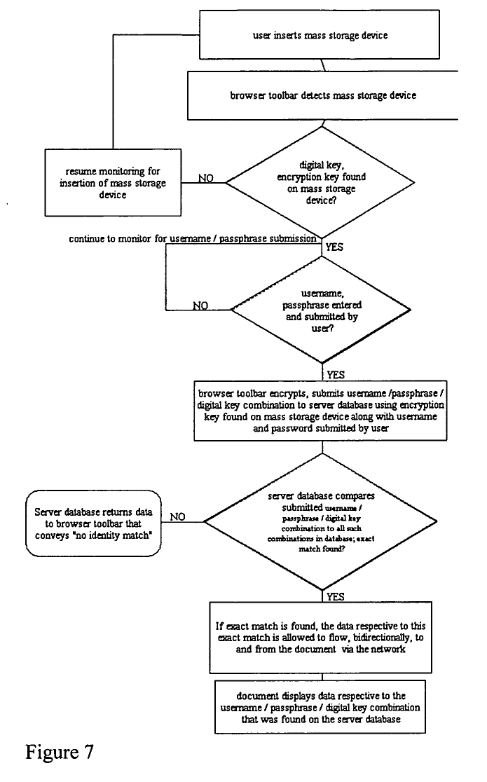

FIG. 7 is a flow chart also illustrative of the process by which a browser tool bar, one possible user interface envisioned according to the current invention, is used to control the bidirectional flow of information to and from the document;

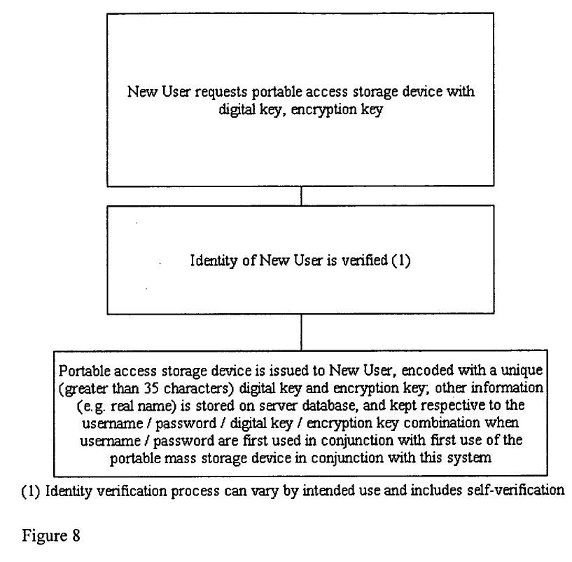

FIG. 8 is a flow chart illustrating one method, according to the current invention, by which a new user is associated within the system with a particular mass storage device, or more precisely, with the unique identifying number (UIN) encoded upon a mass storage device;

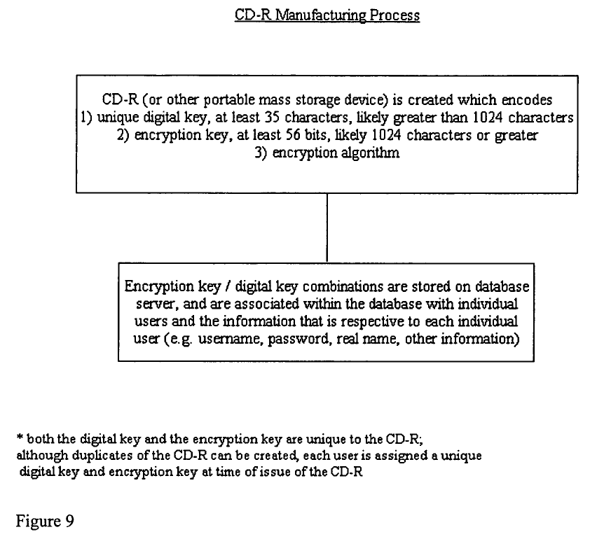

FIG. 9 is a flow chart representative of the system by which the identity of a user is verified by means of the system, according to the present invention, through the use of unique digitally encoded characters which are contained on the mass storage device (CD-R, USB drive, or other device);

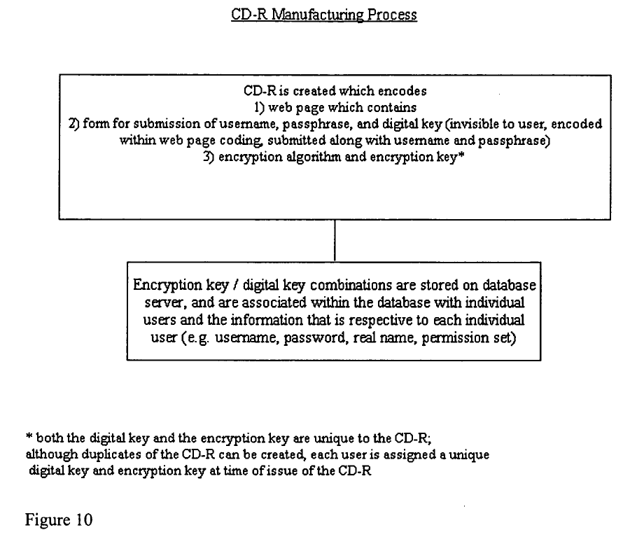

FIG. 10 is a flow chart representative of the process that could be used to create the data on a new user's CD-R (or USB drive), in one possible version of the current system;

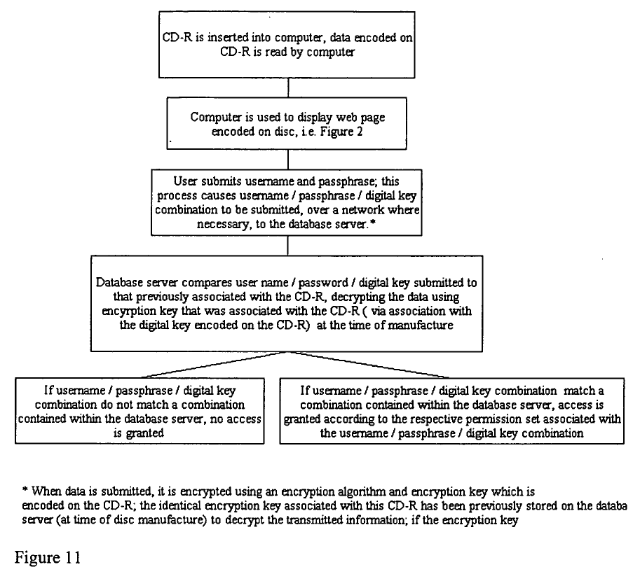

FIG. 11 is a flow chart of another representation of a possible use of the current invention;

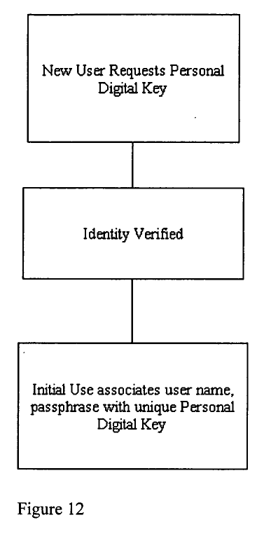

FIG. 12 is a flow chart illustrative of the process by which an individual could be associated, within the system according to the current invention, with a unique digital key;

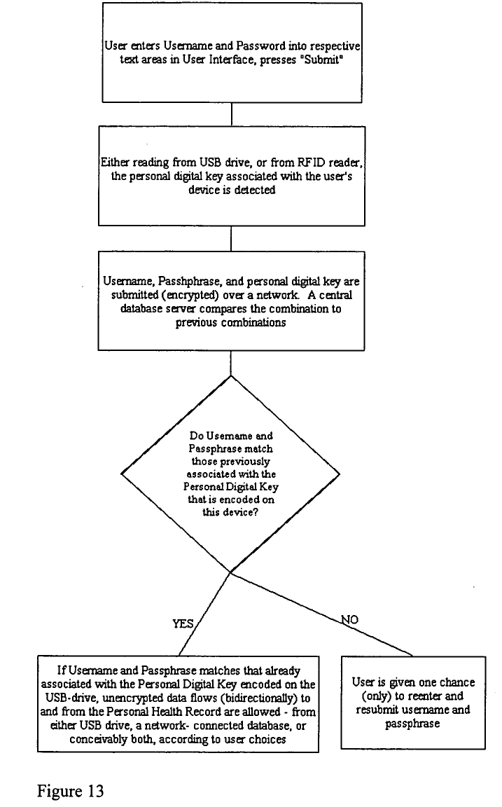

FIG. 13 is a flow chart illustrative of the process by which access to information on a Personal Health Record could be controlled, according to the current system;

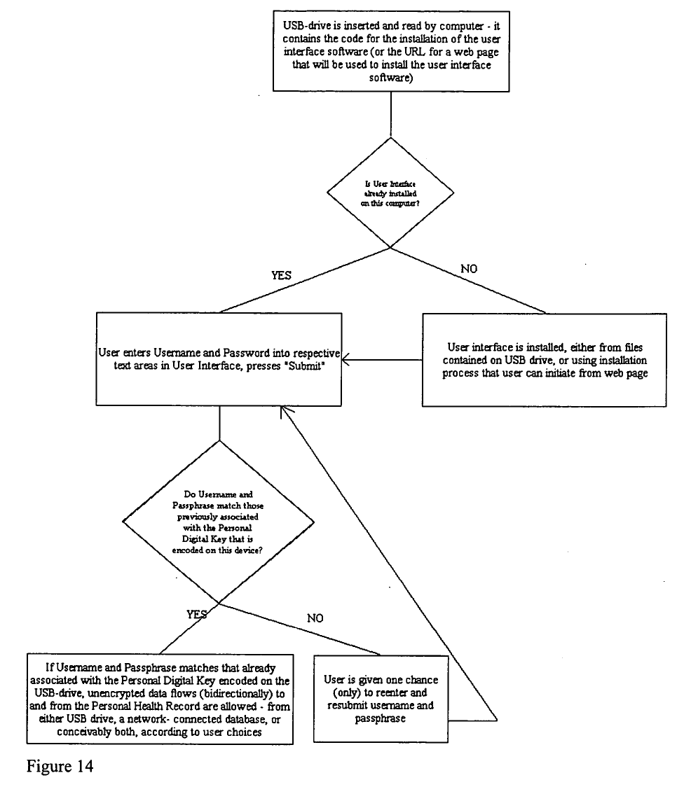

FIG. 14 is a flow chart illustrative of the sequence by which the USB drive, CD-R, or other mass storage device could be used to install all or portions of the user interface, which is then used to view, store, and retrieve information, not just from the personal health record (as shown in this figure), but from any system in which health information has been stored;

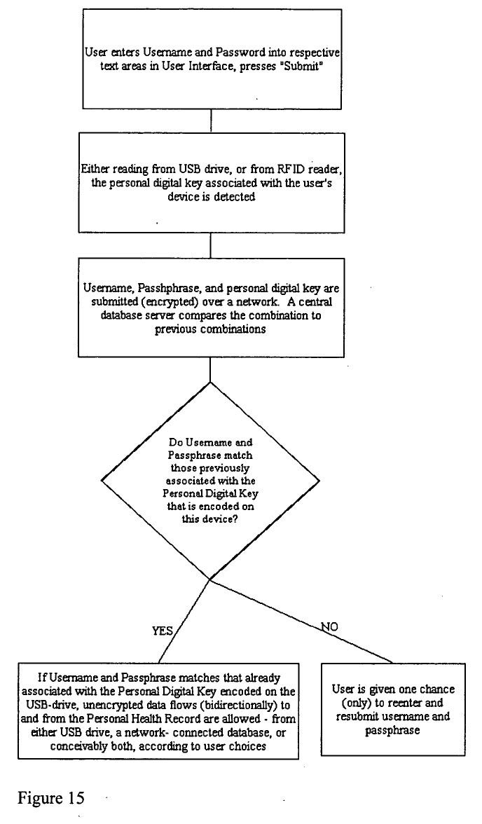

FIG. 15 is a flow chart representative of the process by which the system can control the flow of data to and from the personal health record;

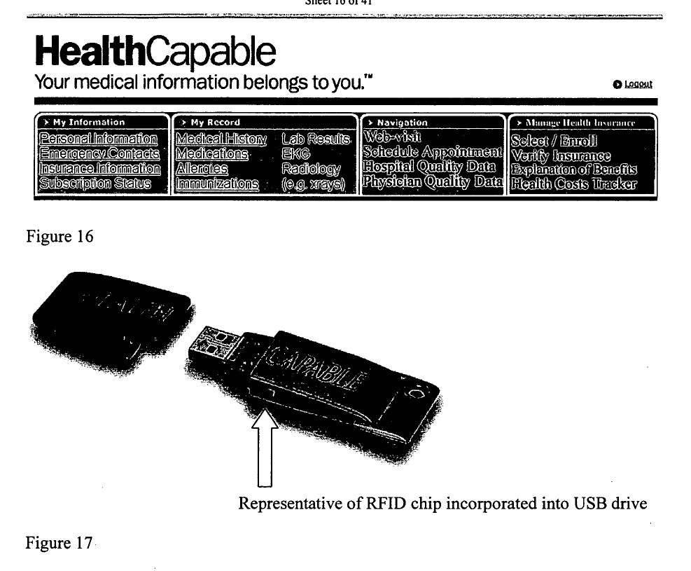

FIG. 16 is a screen representative of links to some different tools that can be incorporated into the system and work with the personal health information stored and retrieved by the system, according to the present invention;

FIG. 17 is an isometric view illustrative of an USB-drive with an RFID chip incorporated into its design;

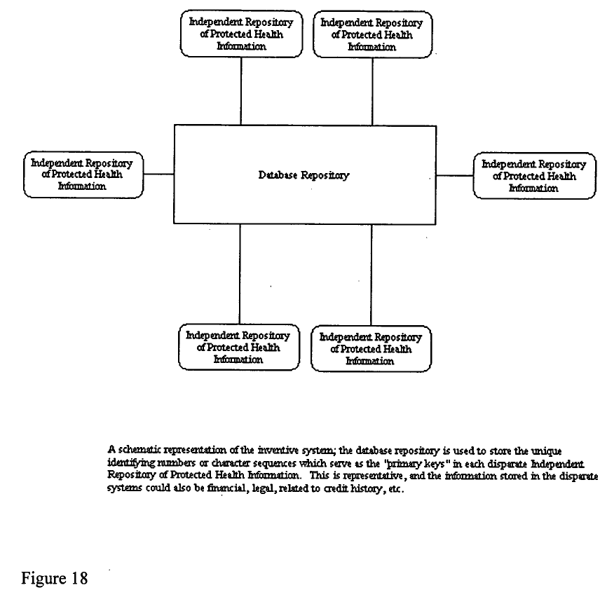

FIG. 18 is a flow chart and schematic representation of an embodiment of the system;

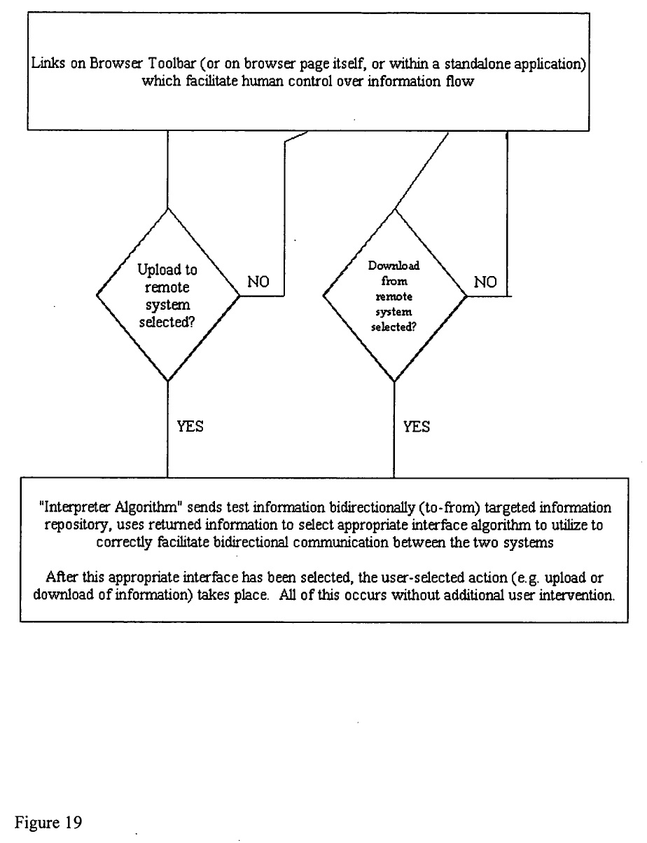

FIG. 19 is a flow chart representation of the “auto-interpreter” functionality—which selects, without additional user intervention, an appropriate application programming interface to use to correctly accomplish the (likely bidirectional) information flow between the user and a remote system;

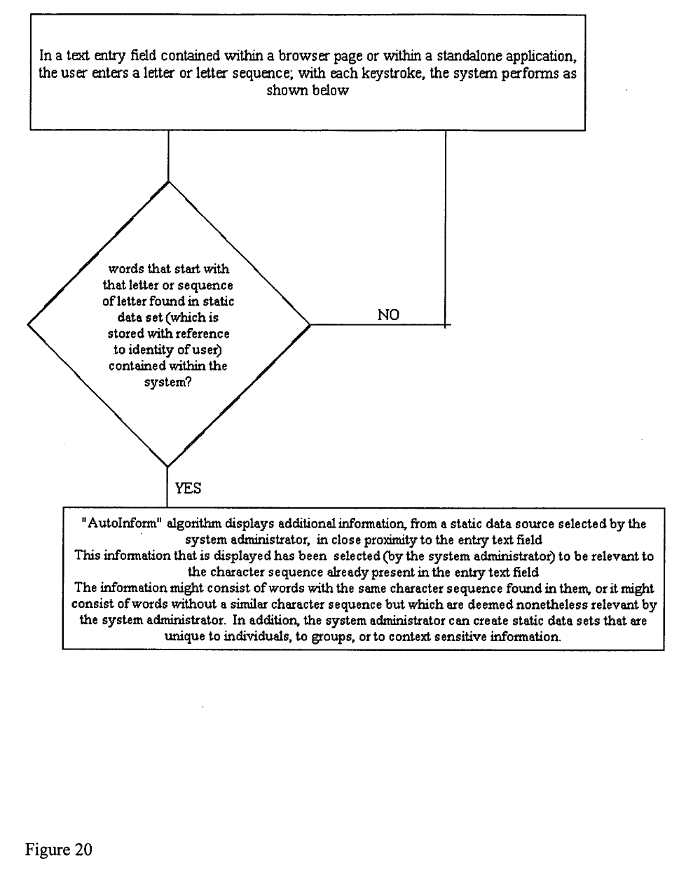

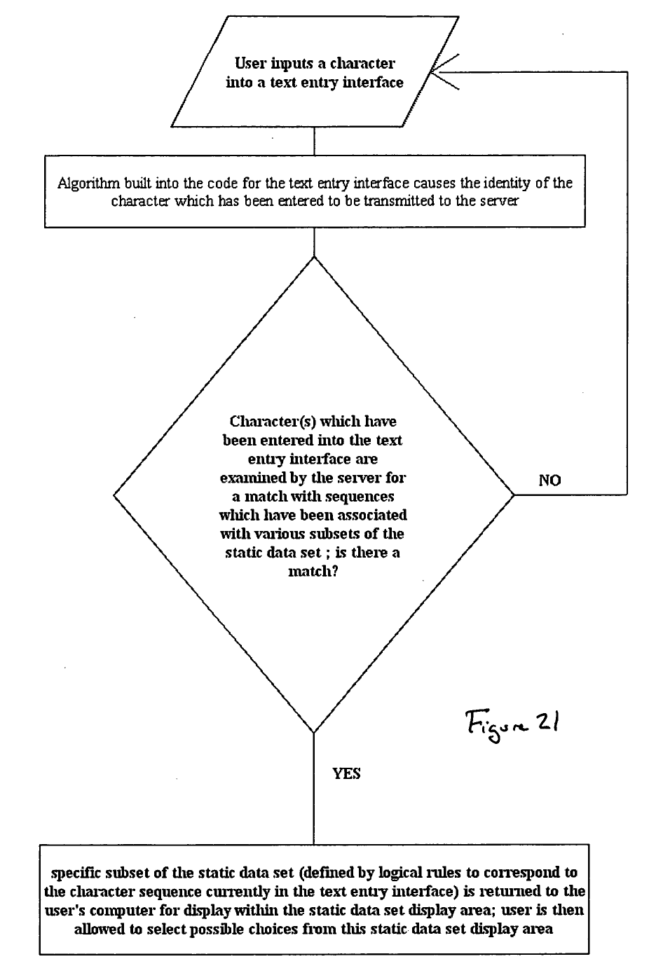

FIG. 20 is a flow chart representation of the “autoinform” feature;

FIG. 21 is a flow chart of the logic employed by the inventive system to display information in the Static Data Set Display Area that is likely to be relevant, according to logical rules, to the character sequence contained within the Text Entry Interface;

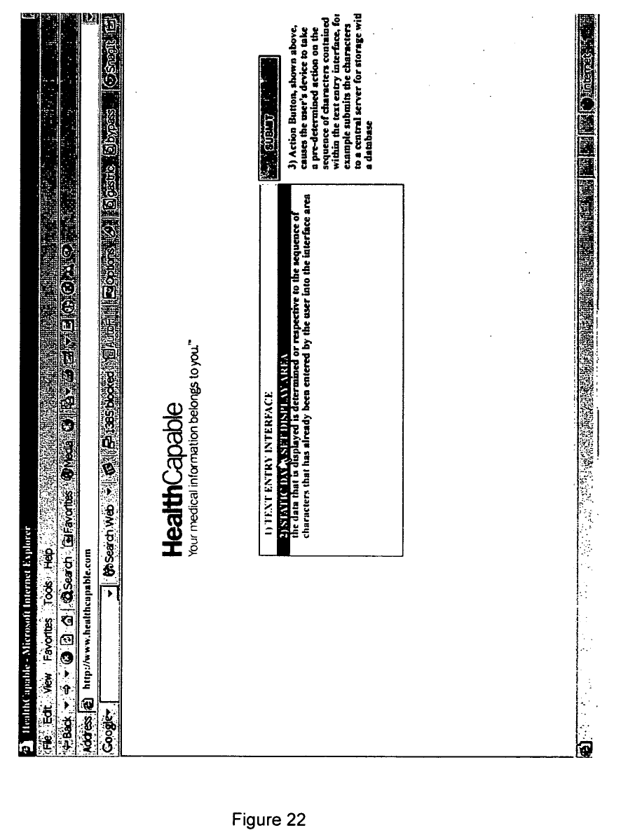

FIG. 22 is representative of a possible screen of one embodiment of the user interface, according to the current invention;

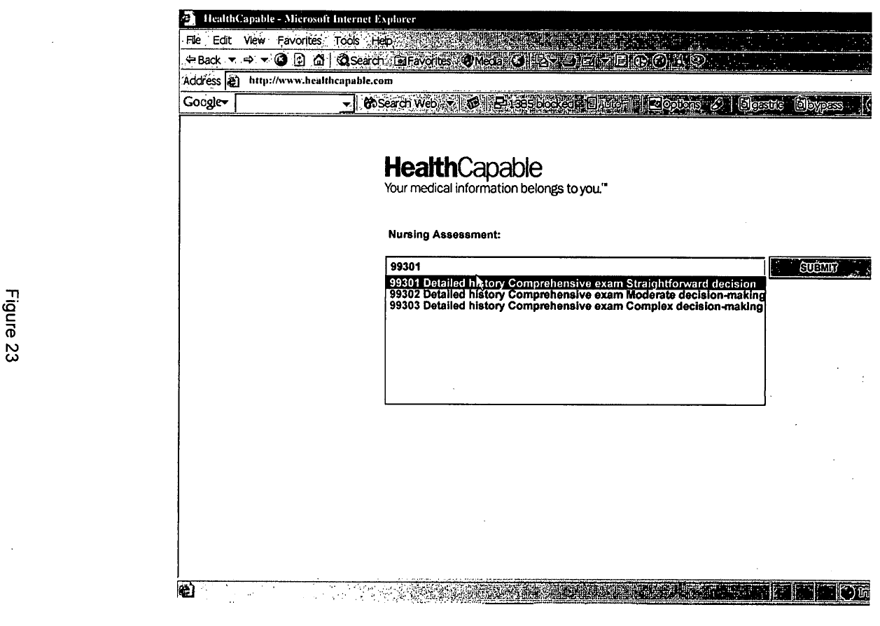

FIG. 23 is a representative screen of one possible manifestation of the current invention;

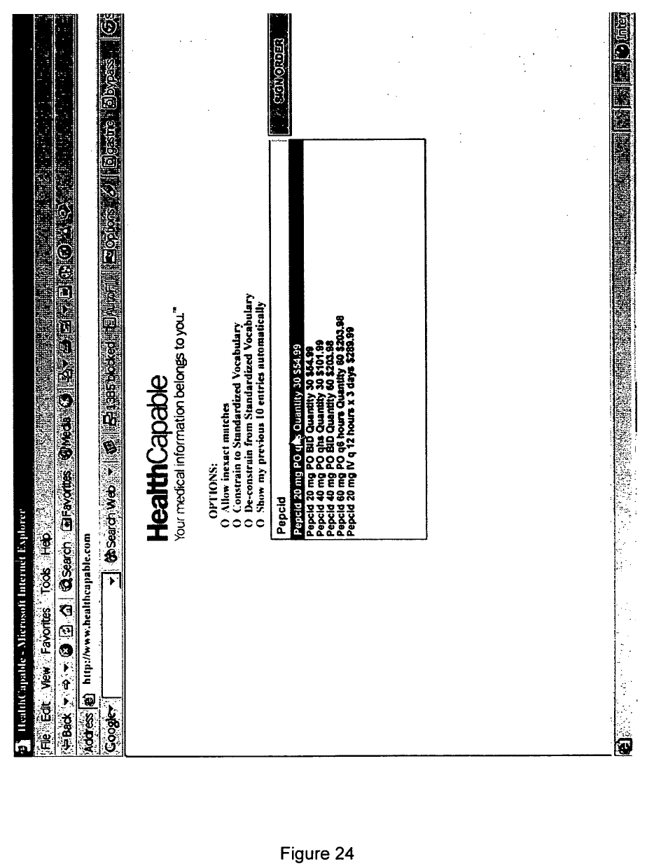

FIG. 24 is a representative screen of another possible embodiment of the current invention;

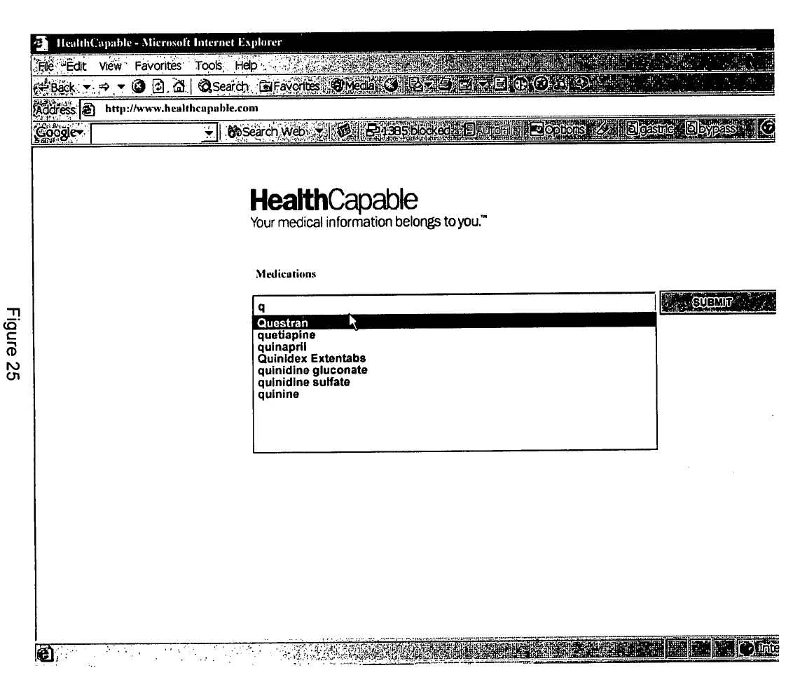

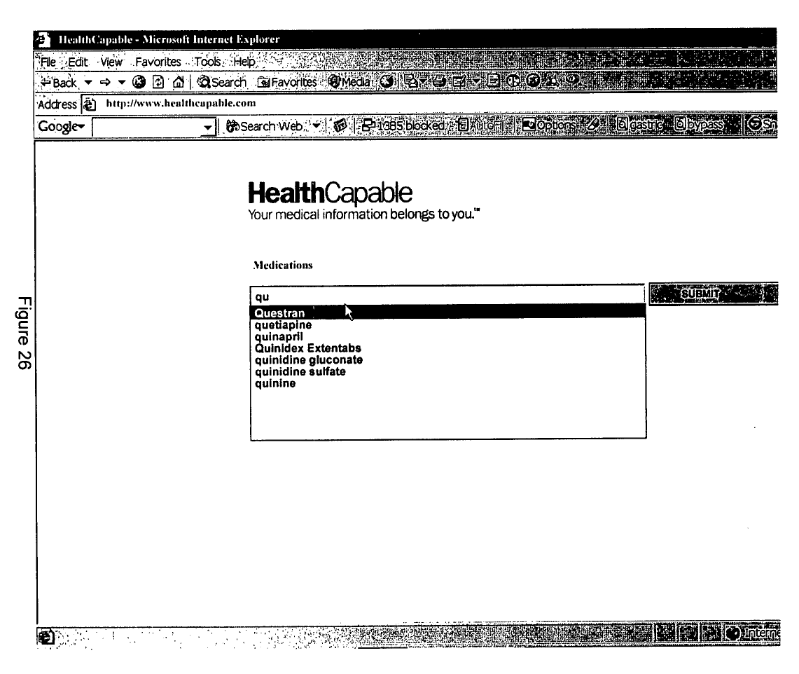

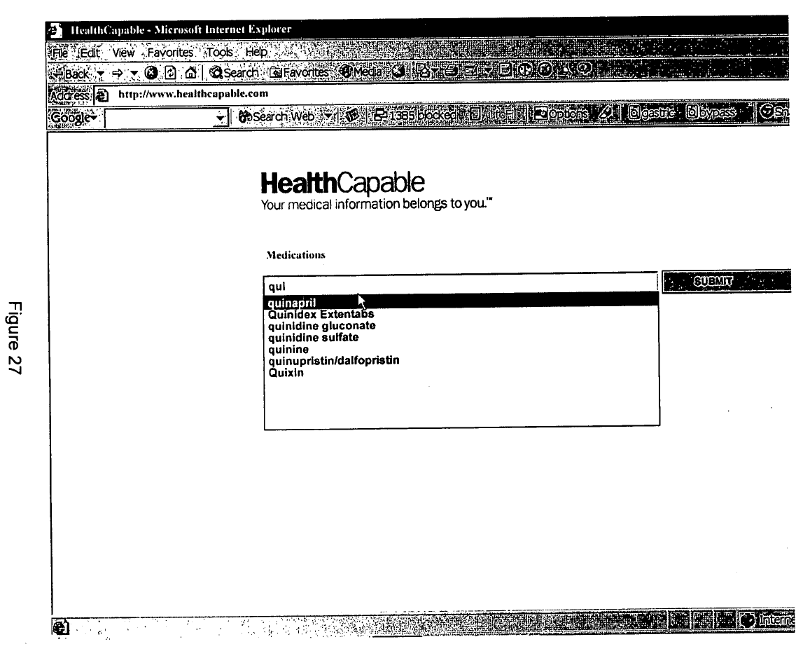

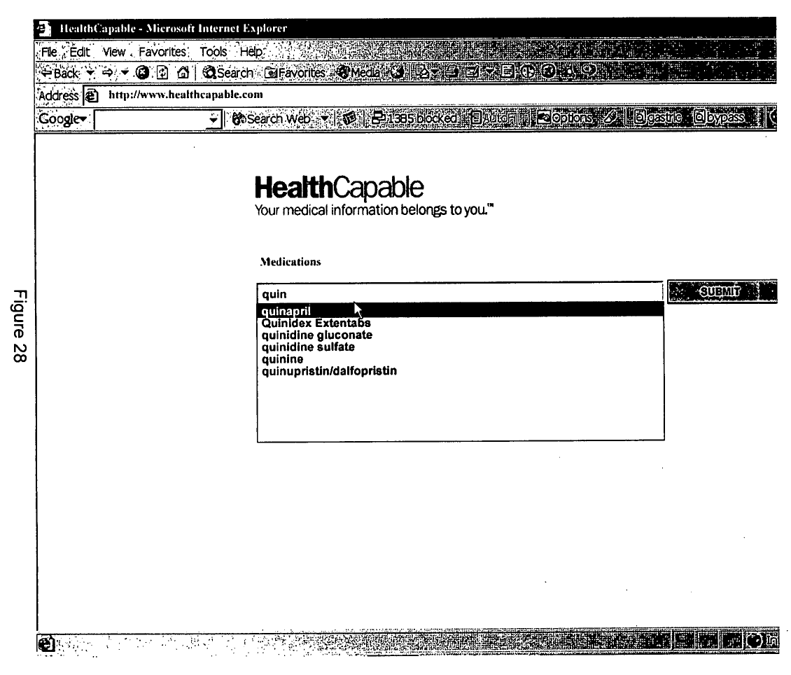

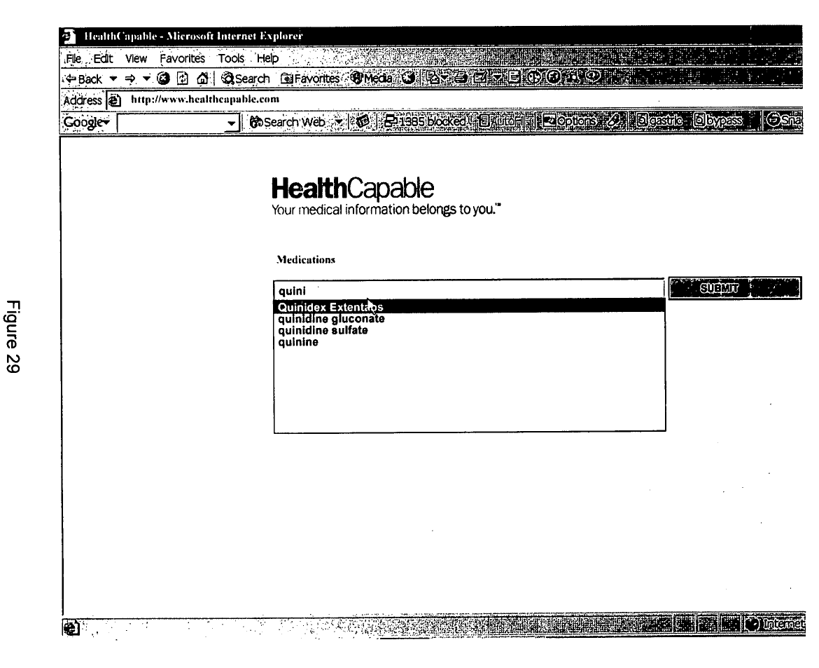

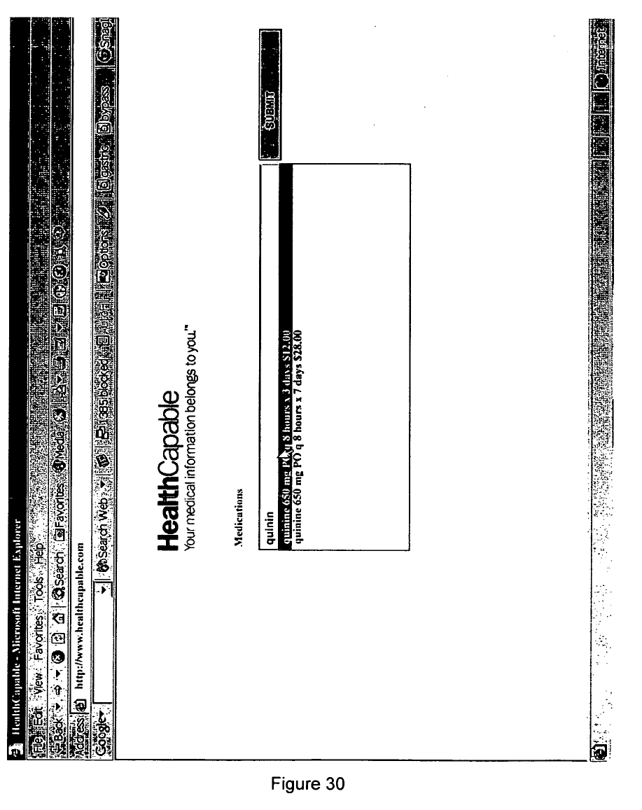

FIGS. 25-31 are illustrative of a sequence of terminal screens—each representing the information that would be displayed on the screen after the user adds a character into the Text Entry Interface area;

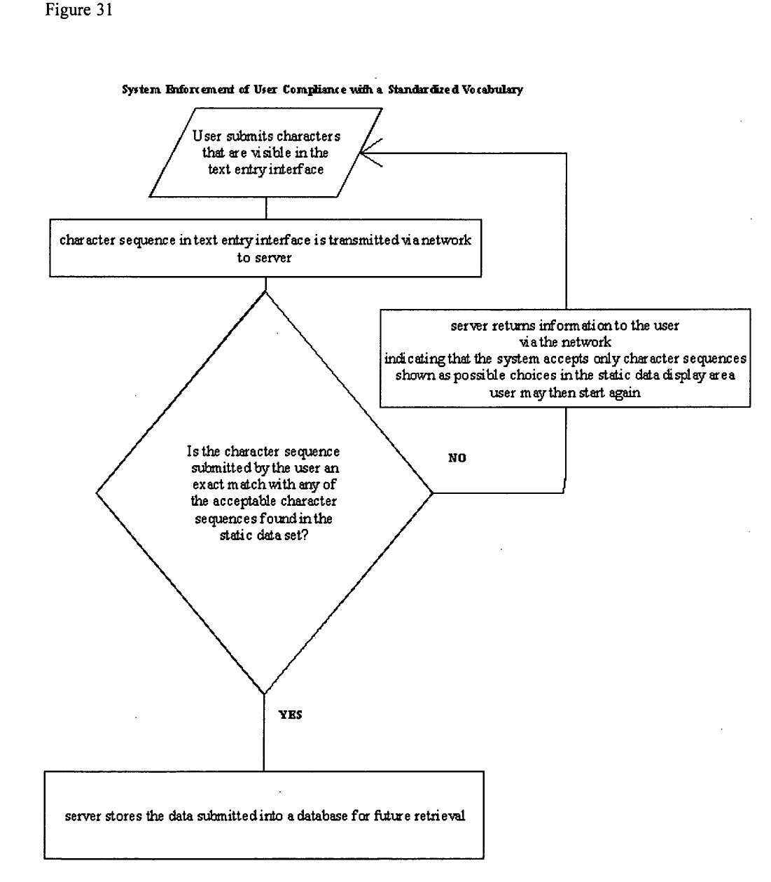

More specifically, FIG. 31 is a flow chart illustrative of the method by which, once the computerized logic has determined a drug the user apparently intends to use, additional relevant information pertaining to that drug can be displayed;

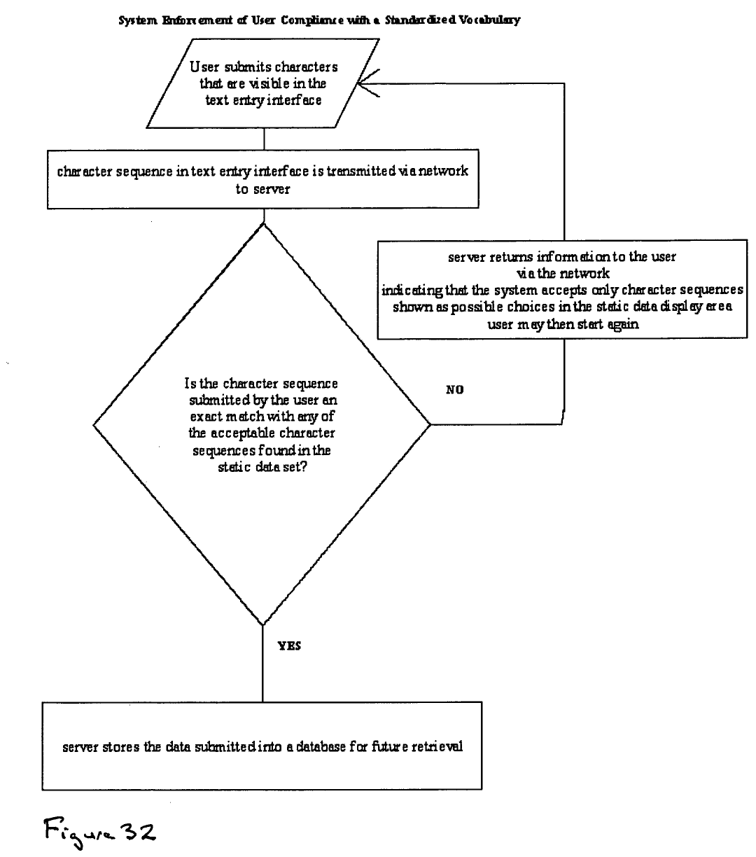

FIG. 32 is a flow chart schematically representing additional steps associated with the example of FIG. 11;

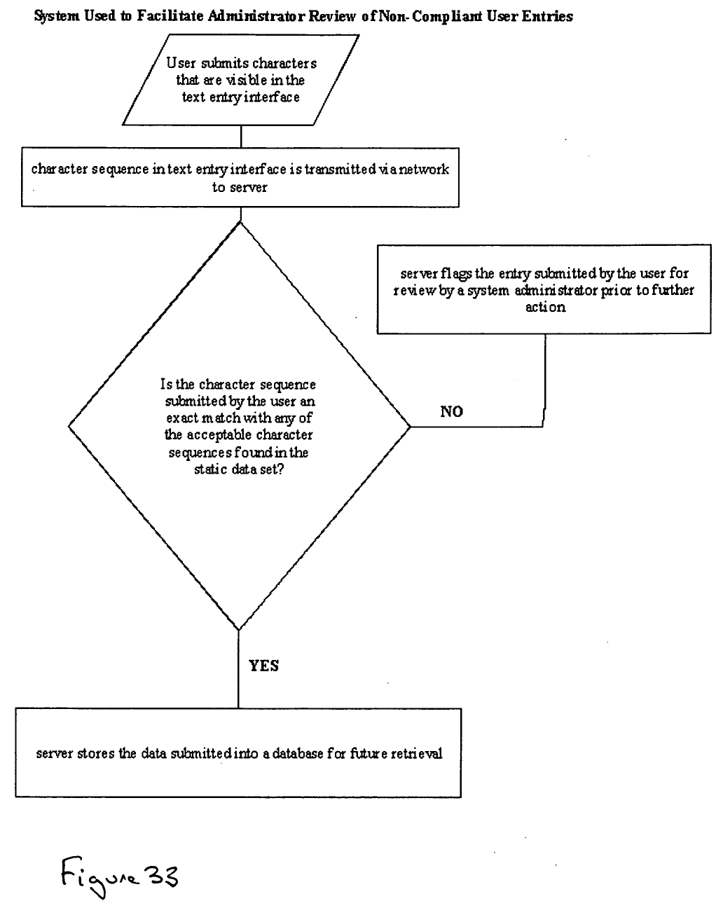

FIG. 33 schematically represents a generic description of the business logic embedded in a system that is used to flag entries that are non-compliant with a list of compliant entries;

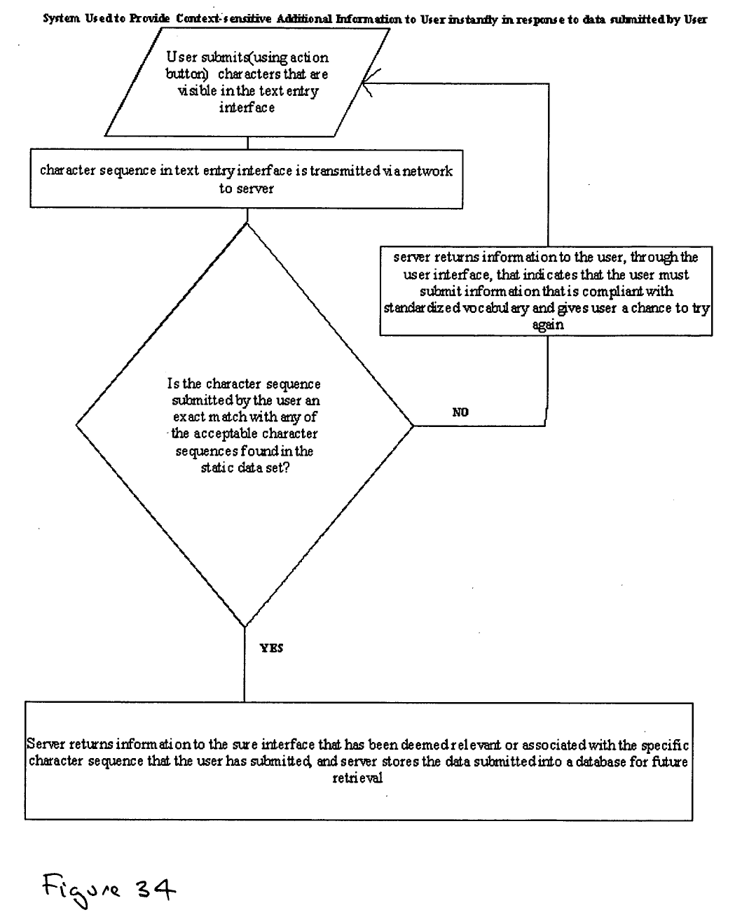

FIG. 34 is a flow chart depicting the ability of the system to provide context-sensitive information to the user in response to the character sequence submitted by the user;

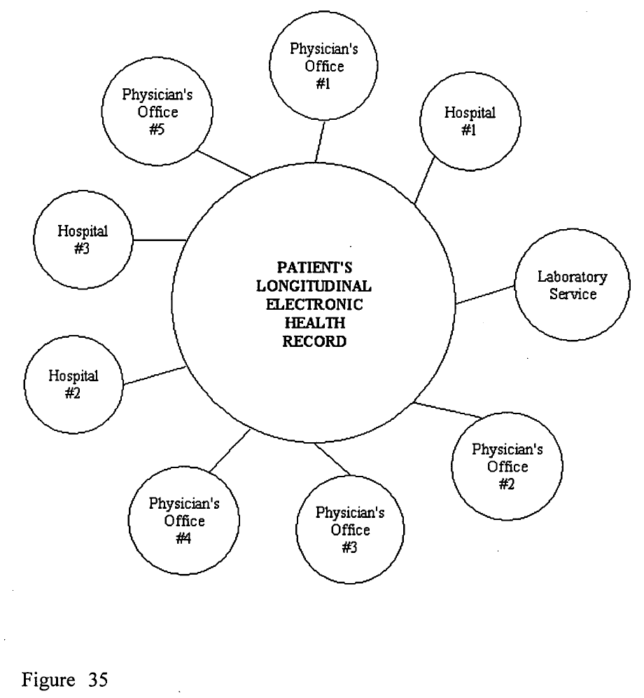

FIG. 35 is a diagrammatic representation of the components of a longitudinal medical health record;

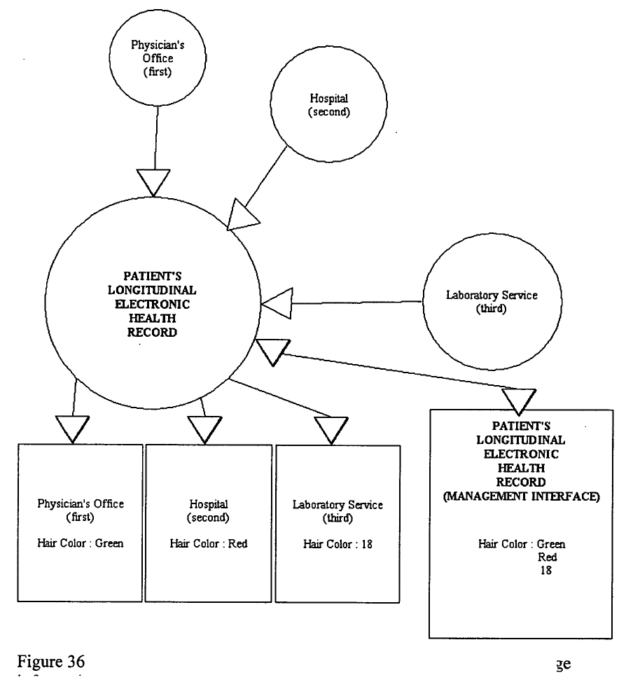

FIG. 36 is a flow chart illustrating the method for assimilating health records and standardizing the nomenclature in a patient's longitudinal health care record;

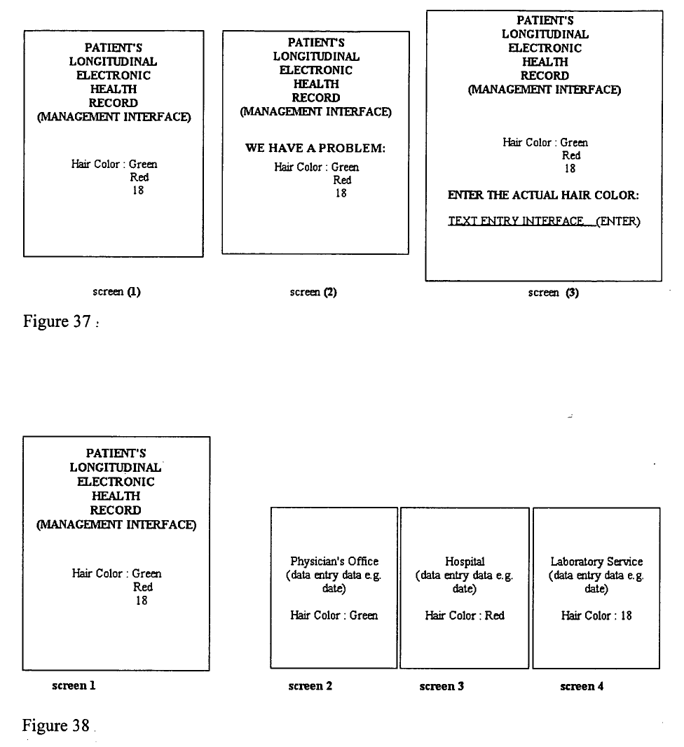

FIG. 37 is a flow chart illustrating a methodology for providing controls over the integrity of a patient's unique health record;

FIG. 38 is a flow chart illustrating a feature of the method of FIG. 36;

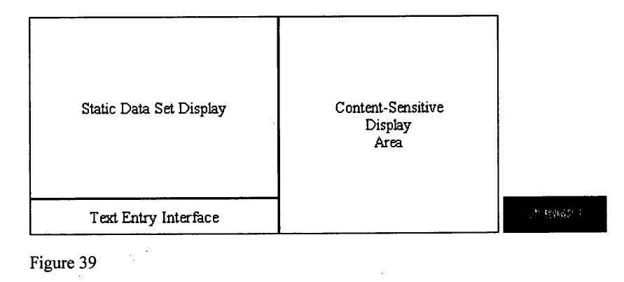

FIG. 39 is a diagrammatic representation of an alternative display of information at a terminal for a user or patient;

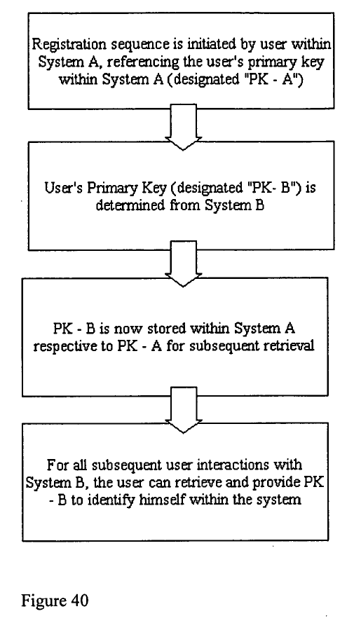

FIG. 40 is a flow diagram illustrating a method for accumulation, storage and necessary access to disparite information from a source relative to a specific patient/user;

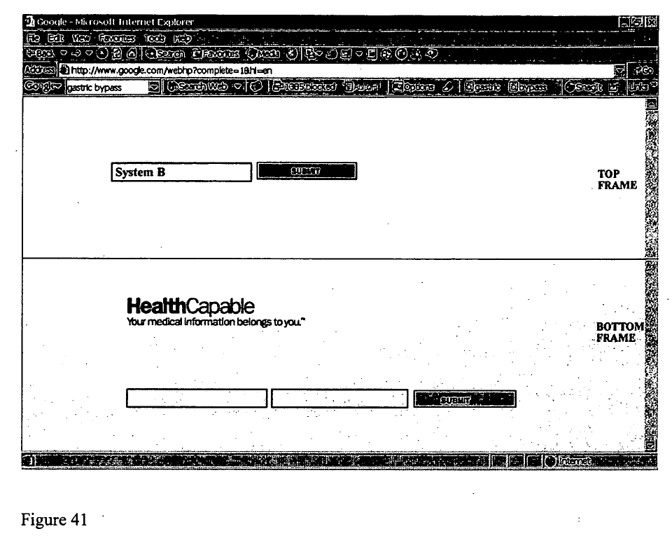

FIG. 41 is a diagrammatic view of a terminal screen associated with a method for retrieval of information from a disparite source for a user/patient;

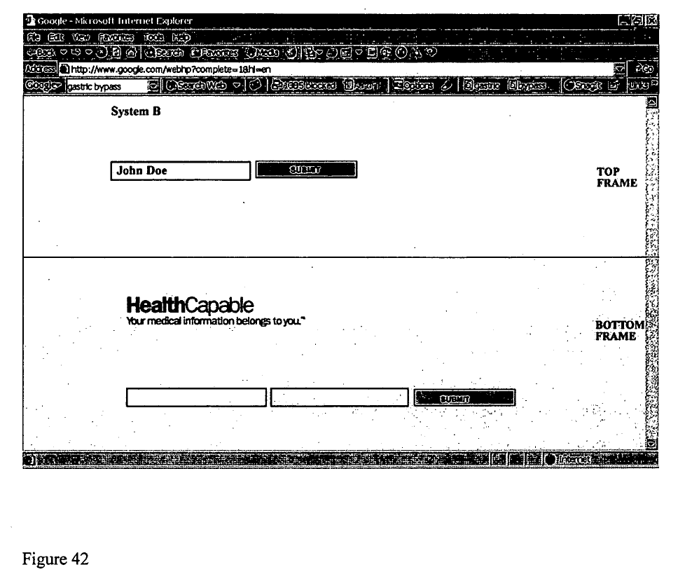

FIG. 42 is a diagrammatic view of a terminal screen associated with the method of FIG. 41; and

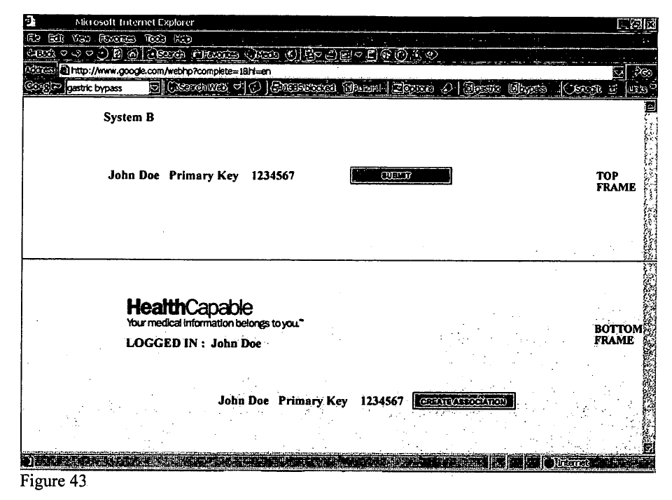

FIG. 43 is a diagrammatic view of a terminal screen associated with a retrieval of information feature of the method of the invention.

### DESCRIPTION OF THE PREFERRED EMBODIMENT

In the following description, various terms will be utilized in their normal sense and context and will include the following additional features with respect thereto:
“User” will mean a patient, a physician, a guardian, or any entity which desires to have access to the electronic medical record system described hereinafter.
“Screen” means the visual presentation at a terminal setting forth and representing information visually to the user. The screen may include tool bars and other information, instructions, and the like which will facilitate use of the information provided to or by the user as well as interactions by or for the user through the terminal to a server.
“Encryption key” means a hardware device which is able to provide storage of an encryption code and optionally a generic software program that provides for transmission of the encryption information and a patient identification program to a remote server through a network and further may provide an optional program for downloading at a terminal to enable the user to interact with such a program as well as programs stored in the server.
“Network” means any means of electronic data transfer communication between servers, terminals and hardware including the world wide web, wireless and wired internal dedicated networks and external networks.
“Patient” means any individual, user, physician, guardian, caretaker or institution.

Overview of the System and Record Keeping Method

FIG. 1A comprises a general overview of the system of the invention and its component parts. Briefly, there is disclosed a central server and storage device 50. This storage device 50 may be located at any convenient place and provides memory as well as programmatic contributions to the operation of the system. The central server 50 receives, over time, unique electronic medical data input from a series of various, disparate providers and sources of medical input information. For example, a first provider 52 may constitute a medical laboratory. A second provider 54 may constitute a physician. A third provider 56 may constitute a source of medical drugs or a source of therapeutic apparatus. A fourth provider 58 may comprise a specialist or another physician. A significant number of providers may thus be involved in the full medical records system. The system does not typically limit the number of providers that may communicate with and submit medical records on a patient by patient basis to the central server 50. Additionally, the central server may comprise a series of linked servers or groups of separate servers each of which is allocated to received medical records for storage and access from a finite or defined group of patients, e.g., all patients within a certain range of social security numbers; all patients from a geographic region, etc. Each one of the providers 52, 54 56 and 58 will provide unique medical information to the server 50 through a network such as the world wide web or a dedicated network or other network means. The manner in which that information is provided to the central server 50 is an aspect of the invention. For example, the provider 52, which is a laboratory, will provide data in electronic format through a network connection 60. Access to the network connection 60 is provided, for example, through a terminal 62. Activation of the terminal 62 requires an encryption code input. Such encryption input may be provided from a number of sources, but in a preferred embodiment, encryption is controlled by means of a hardware device 64, for example, a USB device along with a user name and password. The encryption device 64 includes code which permits medical information inputted through the terminal 62 to flow through the network 60 to the server 50. The information to the server 50 is compartmentalized or segregated on the basis of the encryption code user name and password input uniquely with respect to each patient or entity.

The information gathered and inputted to the server 50 by each of the providers 52, 54, 56, 58 is associated with a single, unique patient 70. The patient 70 will have access solely to the patient record associated with that patient 70 in response to the uniquely provided appropriate encryption information. The patient 70 thereby achieves access to his or her medical records stored in the server 50. Specifically, the patient 70 will have been provided a device 72 which carries an encryption code. This device 72, known as an encryption key, is to be used in conjunction with a unique user name and password to initiate connection via a network 74 to the server 50. The connection will typically be made through an interface, such as a terminal 76. Thus, the encryption key 72, such as a USB device, will physically and thus electronically initiate a program for purposes of communication between the terminal 76 and the server 50 with respect to the patient's unique medical record. The encryption key code may also be incorporated in the terminal 76. In any event, the encryption key code is preferably maintained as part of the separate key device 72 which must be used in order to initiate communications via the network 74 to the server 50.

An important feature of the system is the utilization of a communications program that is a generic program useful for communicating with the server 50. The communications program, which is described in more detail hereinafter, guides or enables the user or patient 70 to communicate uniquely with that patient's record maintained in the server 50. Thus, the terminal 76 may include the communications program. The program becomes useful only when the patient 70 is accessing, via the terminal 72 and the network 74, the unique information of the patient 70 stored in the server 50.

Preferably, patient 70 communication is bidirectional enabling the patient 70 to amend, alter or comment upon information stored in the server 50 at the unique memory or storage site or sites in server 50 memory. The patient 70 will be unable to have access to other stored information in the main server 50. The patient access will thus be confined to his/her own respective personal health information (PHI).

The patient 70 may also include or have included on the key encryption device 72 the interface or communications program so that the patient may utilize any terminal in order to effect communication with the server 50. Thus, there are a variety of options, each one which requires the inclusion of a key device or encryption key device 72 to initiate communication along with a user name and password by a patient.

The encryption key device 72 may be identical in terms of encryption code with the code of the encryption key device 64 utilized by the various providers 52, 54, 56, 58. However, it is preferred that the provider encryption key 64 device code not be generally identical. Rather, it is programmed or coded so that input information can be provided uniquely and only to the single patient record authored by that provider 52, 54, 56, 58. The key device 64 associated with the provider thus will include a code which engages limits to server 50 access. For example, it may enable only unidirectional communication for input to the server 50. It may also provide for bidirectional communication but provide an alert or signal to be forwarded to the patient so as to advise the patient of any alterations or changes made in the record by the provider. In any event, the provider key 64 will include a code which precludes provider access to any record other than the record originating from that provider. However, the patient 70 will have a programmatic option enabling providers to have access to all PHI stored information respective to the patient, regardless of the source of the information.

Preferably, the server 50 includes programmatic software which insures that the information provided to the server 50 meets certain constraints. That is, the interface or terminal program software will be subject to certain standards for input of data to the server 50. The server 50 will further include additional software to unify and normalize the information provided to the server 50 and to facilitate searching of the medical record by an authorized user such as the patient 70 or an authorized physician. Additionally, the interface program may include search features which will facilitate retrieval of relevant data from the server. The program will, in other words, operate on the basis of key words and other types of information which will enable efficient searching, sorting, categorizing and storage of information. The server 50 itself need not include all of the software associated with the maintenance of the longitudinal health records associated with a single patient or entity, but as described previously the key device 72 may include generally used access or directory programs.

Other features of the invention are represented by FIG. 1A. For example, the server 50 may be operated by a service provider such as a Regional Health Information Organization (RHIO) which would initially be comprised of affiliated hospitals, staff, laboratories, physicians, care givers, intermediate and long term care providers and pharmacies. Each would have access to the RHIO operated central server and each would have an encryption code for its list of patients. That code would enable unidirectional input on a unique patient by patient basis to the central server, subject only to input programming criteria to insure clean data and limited bidirectional communication to confirm data receipt and to control the standardization of data, i.e., insure it is clean data. The encryption code would be secured through the patient hardware key plus the user name and password of the provider. This combination of code input would insure communication uniquely solely with the patient's record for input purposes only since the provider would not have the patient name and password. Rather, the combination of key code with provider name and password would limit the provider (via the server program software) to data input only in one preferred embodiment.

The RHIO would preferably create a backup record of all input data on a real time basis. That backup data record would replicate the RHIO data in case of system failure and would immediately be on line upon detection of a system failure. Such redundancy is a preferred feature of the system and would provide a source of information that could be separately used for research.

That is, certain fields of information could be rendered inaccessible for research purposes, such as name, address, social security number, etc. However, other fields of information could be made available for statistical research. Such research access could be subject to pre-access approval by the RHIO or other server operator and could also comprise an income source for the RHIO, e.g., payment for access to the medical information regarding the history of certain drug use. Again, the access to information would require patient permission which would be solicited and obtained upon assignment of and providing the patient with a key device, password, etc. All at the same time the patient would also likely provide various medical instructions such as a living will, organ donation information, emergency instructions, etc.

Emergency access by certain providers could be insured by a combination of the authorized providers key code and the patient name and/or password, and/or encryption key. For example, an emergency medical service (EMS) may have an encryption key device which in combination with the device or password and/or name of an accident victim provides access to that victim/patient's medical record. Thus, the patient/victim may have an RFID device, a USB device, or even a “smart card” which in combination with the EMS encryption key will permit access to the unique medical record of the patient/victim. The available information will typically, in such circumstances, comprise an emergency subset of patient information per a program which limits the information to the “need to know in emergency situation.”

As can be seen, the system eliminates duplication of records, standardizes record keeping, permits access as needed, provides for contribution of information by multiple sources and most importantly is dependent upon patient participation.

### EXAMPLES OF THE SYSTEM

With this overview in mind, there is set forth hereinafter a description of various features and alternatives as well as flow diagrams describing the methodology of the operation of an example of system.

FIG. 1 depicts a representative encryption key device; namely, a CD ROM disc for insertion into a terminal 76 that has access to a network 74 communications with a server 50.

FIG. 2 serves as one possible user interface or screen at terminal 76 by which the health care consumer (user, patient) can submit his username, password, and the unique identifying number (UIN) which is encoded on the web page as a hidden field. For the manifestation shown above (e.g. a web page), the UIN which serves as the encryption key on the database server is submitted as a hidden value when the user clicks on the “Submit” button. In this example, the UIN is incorporated into the sign in protocol of the patient terminal 72.

Referring to FIG. 3, the user can select action buttons to perform various tasks associated with the personal health information (PHI), e.g. edit the entire record, edit or delete isolated fields contained within the record, print the record, reveal authorship data, pass on the encryption key (and thereby reveal data to) researchers or marketers. This image or screen helps convey some of the objects of the current invention: tools or links which are common to all users are shown in the upper portion of the screen, e.g. “medical references,” “disease information,” “Medication information.” Although the links are common to all users, they can be used to convey PHI that is specific to the user pursuant to an algorithm that will then display data that is specific to the PHI conveyed. For example, clicking on the “medication information” link can convey all of the medications listed in the user's list of medications to the algorithm used to display information—so the information displayed after clicking on this link is specifically information pertaining to the user's medications.

In FIG. 4, “encryption key 72” can be considered synonymous with the “unique identifying number (UIN) referred to in other parts of the document. According to the present invention, the UIN is used as the encryption key. FIG. 4 is a flow diagram depicting the steps in access to server 50.

Referring to FIG. 5, an “autointerpreter” feature can be incorporated into this code. This functionality enables the automatic selection of the appropriate application programming interface algorithm that correctly accomplishes the (bidirectional) flow of information that the user desires, without additional input on the part of the user. This is further illustrated in FIG. 19.

FIG. 6—The action button can also be located within the document, and the features described can still be associated with the button (e.g. user identity verification). In the figure, “digital key” can be considered synonymous with the “unique identifying number (UIN) referred to in other parts of the document. According to the present invention, the UIN is used as the encryption key.

FIG. 7—In the figure, “digital key” can be considered synonymous with the “unique identifying number (UIN) referred to in other parts of the document. According to the present invention, the UIN is used as the encryption key.

FIG. 8—According to the current invention, the “digital key” referred to in the figure is synonymous with the UIN referred to throughout this document, and also synonymous with the “encryption key” referred to throughout this document.

FIG. 9—In this figure, unique digital key and encryption key are considered to be separate; this need not be true, however, and, according to the current invention, the unique digital key can be used as the encryption key by the server to encrypt/decrypt information.

FIG. 10—In this version, the encryption algorithm that utilizes the user's encryption key could be encoded on the user's CD-R, and this encryption could take place actually on the user's computer, prior to transmission of data over a network. Alternatively, the encryption/decryption process could take place on the server, using the encryption key submitted by the user in combination with the username and password combination also submitted by the user.

FIG. 11—In this version, access to the (potentially bidirectional) flow of information is regulated according to specific “permission sets” which have been previously associated with the username/passphrase/digital key combination. The phrase “permission sets,” in this context, is meant to signify that varying level of access to information can be allowed—determined by either the user, or by another administrator of the system.

Referring to FIG. 12, the system could be used to associate a unique set of digital characters on an RFID chip with an individual via first use association with a username and password: This version of the system would involve any encryption algorithm used being stored on a different medium, e.g. the code associated with the browser bar, or the code associated with the web page or document being compiled, or the server with which the user interface is designed to interact.

Referring to FIG. 13, the system flow diagram depicts a system that can similarly be used to control access to any other electronic health record—in the sense that the system can disallow any flow of information from any data source if the username, passphrase, digital key combination submitted are not a match with a combination found within the system. In one possible implementation of the system, the information could be passed over the internet using SSL (one type of encryption) and then encrypted and stored on the server 50 using a different encryption key (the unique digital key submitted by the user) and different encryption algorithm which is stored and which executes on the server.

FIG. 14 depicts in a flow diagram another protocol for access to PHI on server 50. As depicted in the flow diagram of FIG. 15, the same process can be used to control the flow of data to/from any other source. Although the figure refers to bidirectional unencrypted data flows, and this is indeed one possible manifestation of the current invention, the current invention also allows for the bidirectional flow of encrypted data only where desired.

Referring to FIG. 16, for example, clicking on “web-visit” can open a page that is pre-populated with the personal health information that is specific to the user, including a further link to submit the information to physician(s) previously associated with this patient. As another example, clicking on “hospital quality data” can open a page populated by data that is specific to hospitals within a specific geographic region defined by the zip code shown in the user's personal information.

FIG. 17 depicts a combined USB/RFID encryption key 72. Note that this is a representative image only. In the preferred embodiment, the RFID chip would not be externally exposed, but would be contained within the USB drive.

Referring to FIG. 18, the database repository (server 50) is used to store the unique identifying numbers or character sequences which serve as the “primary keys” in each disparate Independent Repository of Protected Health Information. The information stored in the disparate systems could also be financial, legal, related to credit history, related to prior purchases, etc.

FIG. 19 is a flow diagram setting forth a protocol for bidirectional information flow in such a system.

FIG. 20 is a flow diagram setting forth examples of a topic search protocol by a user:
1) information within the system (whether previously entered and imported or entered by a current individual user) is found to be inconsistent with a standardized vocabulary. In this case, the information from the static data set that would be displayed near the text entry field would have been previously been selected, by an administrator, to be likely to be useful in selecting information from a standardized vocabulary with the same or nearly the same meaning. The user can then select from the information which is displayed from the static data set;
2) the system administrator creates static data sets which are relevant to the data already present in the text entry field—regardless of the letter sequence. For example, if the user keyed in “Pepcid,” the static data displayed could show “Pepcid,” and price data for Pepcid, “Zantac,” and price data for Zantac, and “Tums,” and price data for Tums;
3) the system administrator creates static data sets which are relevant to data entered in other (linked) text entry fields; for example, in the text entry field representing “Drug Name,” if the user had entered “Acetaminophen,” the linked data entry field could then display only choices appropriate to “Acetaminophen.”

Several system administrator controls on this feature are possible, some of which have been previously described:
1) allow (or disallow) matches to character sequences anywhere within a word, not just consistent with the initial character sequences;
2) allow (or disallow) data from other static data sources to be incorporated into the data displayed as options, e.g. pricing information for a list of drugs—giving the user pricing information on various drug alternatives at the point of decision; and
3) allow (or disallow) user—specific static data content lists; i.e. create static data content lists which are previously designated by the user, previously designated by the system administrator as relevant to the user's needs, or previously designated by the system administrator as relevant to the type of user's needs. For example, if data stored on the user designated him as a gynecologist, the static data lists utilized within the system could be limited to information specifically relevant to the practice of gynecology.

FIG. 21 depicts alternative search/sort protocols. Exact character sequence matches represent a way to define the subset of the Static Data Set that is displayed within the Static Data Set Display Area. Obvious ways are also envisioned, including logical alternatives to the information represented by the character sequence in the Text Entry Interface area, according to pre-defined business logic rules.

FIG. 22 is a screen associated with a search protocol. The following items are shown within the image: the Text Entry Interface, which, when it receives focus (i.e. when the user places the cursor herein), automatically submits all characters entered herein to the server for examination without additional action on the part of the user (i.e. on every key up):
1) the Static Data Set Display Area, which is the area used by the system to display a subset of the Static Data Set that the system designer or administrator has deemed, through electronic rules, to be relevant to the user who has entered a specific sequence of characters within the Text Entry Interface. The Static Data Set Display Area in the figure includes a top line which is currently highlighted—shows as a grayed area in a black and white rendition of this document—and the user can cause, for example. by pushing the enter key or by selecting it with a mouse and clicking on it, the highlighted data is to replace whatever sequence of characters is currently in the Text Entry Interface area. In addition, the user can select, by pushing up and down buttons, for example, or by placing a pointer over the selection, any of the options displayed to be highlighted. In this manner, the user can cause any one of the selections shown in the Static Data Set Display Area to replace the characters which are shown in the Text Entry Interface; and
2) An Action Button, which causes information contained within the Text Entry Interface to be acted upon by the computerized device. The actual action taken by the computerized device may vary, but in a preferred embodiment of the current invention, when the user clicks on the action button, the contents of the Text Entry Interface are submitted to a server for evaluation by an algorithm that resides on the server.

FIG. 23 is a screen that represents one possibility of the amount and type of information that would be displayed to the user within the Static Data Set Display Area, in this case additional information pertaining to a sequence of characters that consists of a code number frequently used in association with medical billing.

FIG. 24 is a screen example where the user has entered “Pepcid” into the Text Entry Interface; the system has returned data pertaining to Pepcid from the Static Data Set that pertains to the cost and dosing of various regimens of Pepcid. FIG. 4 also demonstrates some of the optional features associated with the inventive system—including allowing inexact matches, constraining responses to a standardized vocabulary, deconstraining responses to a standardized vocabulary, and showing a user's previous 10 entries automatically. Although this figure represents a user interface, the controls for all of these options could, instead, remain the choice of the system administrator, and this may be more logical.

FIG. 25-31 comprise screens in sequence wherein the user types letters for a search in the following keys sequentially: q, u, i, n, i, n, and the information displayed in the Static Data Set Display Area changes correspondingly. When the user has input all of the letters in the illustrative sequence (“quinin”) this is sufficient information for the system to use to determine that the only drug contained within the Static Data Set that matches this sequence of letters is quinine; having therefore determined via this logic that the user seems to intend to use quinine, only information relevant to quinine is displayed in the Static Data Set Display Area.

FIG. 32 is a flow diagram wherein the user selects one of the choices shown in the Static Data Set Display Area, and it will by definition be an “acceptable character sequence” in the language of the Figure, and will be stored in the database as clean data. If the user does not select one of the choices shown in the Static Data Set Display Area, but types it manually, it would also be an exact match with an “acceptable character sequence.” If the user enters a character sequence that is not an acceptable character sequence, the system will reject it and offer the user an opportunity to try again.

FIG. 33 is a further screen demonstrating that, via the sequence illustrated in FIGS. 25-32, compliance with acceptable drug dosing instructions could be guaranteed. In this example, the “acceptable character sequences” would include all drug dosing instructions considered acceptable by a system administrator, and non-acceptable drug dosing instructions would be automatically rejected by the system. Also to be noted—using a system such as the one described, any new drug order written by a prescription could be checked for possible interactions with the existing drug orders in force for a given patient—and the fact that there was clean data within the list of medications being given or prescribed for the patient would greatly facilitate machine checking against a list of known drug interactions. This figure can be interpreted in light of a specific use case which is one preferred embodiment of this system—a system which automatically flags for review any drug dosing regimen that is not compliant with a pre-defined list of acceptable drug dosing regimens. The logic illustrated in FIG. 33, in combination with the inventive system illustrated in FIGS. 25-31, provides a patient safety system.

Referring to the flow diagram of FIG. 34, the ability of the system to generate clean data, in conjunction with a logical association of “additional information” with any given sequence of characters that is considered an “acceptable character sequence,” represents in the ability of a system to provide additional, context-sensitive information that will be pertinent to the user who has entered the data AT THAT TIME. For example: a physician, entering a diagnosis, could be immediately referred to best practice guidelines for care of patients who carry that diagnosis. With dirty data this would either not be possible, or be possible only on the occasions when the doctor managed to enter, by hand, the exact character sequence that had previously been associated with this information. With clean data, this association between diagnosis and information relevant to the diagnosis is much stronger and more reliable—essentially, every time a physician intends to enter a specific diagnosis, he or she can be referred to information that is relevant to that specific diagnosis. With the dirty data methods fairly typical of current databases, any association between a diagnosis entered by a physician and relevant information to then be displayed would be dependent on the physician entering a specific character sequence that he might not even be aware of (i.e. the physician who has misspelled a particular disease name all of his life).

FIG. 35 is a schematic illustration of the ability of the system to longitudinally accumulate and store electronic information from disparate sources. It is intended to be a general representation of the concepts that the inventive system addresses—giving the patient access to and some level of control over access to his/her electronic personal health information which is derived from disparate, previously unconnected sources.

FIGS. 36-38 comprise a schematic illustration of the algorithms used in the inventive system to accumulate data, from disparate sources, into one management interface that allows the user to view an actively managed summary view of the longitudinally created data. As a group, the figures also illustrate the system's use to transform dirty data—data that is inconsistent with the form or meaning anticipated by the database designer—into clean data, or data that is consistent with the form or meaning anticipated by the database designer.

In FIG. 36, three disparate sources of personal health information (PHI) are illustrated:
a Physician's Office, a Hospital, and a Laboratory Service. The data regarding a specific individual is transmitted to the patient's longitudinal electronic health record via a network. The data coming from the three sources is shown, representatively, in the three rectangles representing the three sources; for this illustration, each data source had a different entry for the patient for a given data field (“Hair Color”). The Management Interface for the patient's longitudinal electronic health record is representative of the ability of the authorized user to view all data entered for a given field from the disparate sources—and manage such data. Subsequent uses of said Management Interface would involve the user managing entries for any given field that were new since the user, or any user, had last actively managed the data—this illustration is not intended to suggest that every bit of data would have to be re-reviewed by every user every time; actually, the system works to provide users with an efficient means of reviewing data that involves the ongoing system of management outlined here. This is intended to keep an up to date set of visible data that can be immediately visualized and which is generally free of repetition and contains generally or only “clean data.”

FIG. 37 is further illustrative of the process used by the inventive system to create and maintain “clean” data despite integrating data from disparate sources which generally contain and introduce “dirty” data. This figure could be considered a continuation from FIG. 36; screen (1) for FIG. 37 corresponds to the Management Interface screen of FIG. 36. Within FIG. 37, screen (1) shows the actual entries, from disparate sources of information, for a data field; screen (2) is representative of the fact that an electronic algorithm can be used to detect data which is non-compliant with the database designer's intent, and screen (3) is representative of the user of a Text Entry Interface (as described elsewhere within this application) to allow a user to select an appropriate entry for the specific data field that is correct, thereby creating “clean data.” Other user interfaces could be used, and an electronic algorithm could also be used to sort and select appropriate data to create clean data out of dirty data.

FIG. 38 is illustrative of the process by which a user can look at the source of user-designated data, according to the current invention. This figure could also be considered a continuation from FIG. 36. For this illustration, screen 1 is representative of the Management Interface shown in FIG. 36; by clicking on, selecting, or otherwise designating the information that the user wishes to see the source of, the user would be allowed to view both the information and data regarding the source of the information. For example, by clicking on “Green” on screen 1, the user would next see screen 2, which provides additional information regarding the source of that particular data. By clicking on “Red” on screen 1, the user would next see screen 3; etc.

FIG. 39 is illustrative of one preferred embodiment of the way in which information would be displayed to the user using our preferred Text Entry Interface. While it is considered likely that this method would be utilized in the context of a web-browser, and thus can be interpreted as a means of dividing up a display area, the method is also amenable to use in other computerized settings (e.g. within applications separate from web browsers. This figure can be used to visualize the method described, according to the current invention, to provide context-sensitive information.

FIG. 40 is illustrative of a preferred method, according to the current invention, to allow the accumulation and retrieval of primary keys for disparate system.

FIG. 41 is illustrative of a screen capture of one preferred method, according to the current invention, to allow the accumulation and retrieval of primary keys for disparate system. According to this method, the user inserts a CD-R, USB-key, or other means of storing information electronically. A file on the CD-R, known as a “registration file,” is opened by the user—and causes two frames to be created within the browser: a bottom frame, which is intended for the user to log in to the inventive system (“System A”), and a top frame, which is intended for use by the user to select a separate information source which uses a separate primary key to identify users (separate from System A). This figure is illustrative of the user entering “System B” to select System B as the source of additional information (and the source of a separate primary key). This system will be designated System B in subsequent figures.

FIG. 42 is representative of a subsequent screen capture to FIG. 41. The user has typed in “John Doe” and will submit it to System B to retrieve the primary key associated with John Doe.

FIG. 43 is representative of a screen capture subsequent to FIG. 42. The interactions with System B are represented in the Top Frame. The illustration is demonstrative of the fact that interactions with System B have recovered the primary key used by System B respective to John Doe; the primary key in the illustration is 1234567. This primary key has also been passed electronically to the bottom frame which will be used to create an association, within the inventive system, between John Doe and the System B primary key that has just been recovered.

While various embodiments and variations have been set forth and described, the invention is limited only by the following claims and equivalents.

1. A medical record system comprising, in combination:
a) a central server and data storage device capable of receipt and storage of medical data from multiple external sources, translation of said data into selected formats, transmission of said data and portions thereof in response to internal and external commands for access to said data in response to a first and a second encryption code instructions only; said first and second encryption code instructions each comprising a unique multiple bit encryption code, a password and a name;
b) at least one external input source of medical data in the form of a standard set of medical terminology, said external source including a means for access through a network to and interactive connection for transmission of data with the central server and storage device upon entry of said first encryption code;
c) a patient encryption set compatible only with said server second encryption code, said patient encryption set including a multiple bit hardware device having a unique encryption code, said device selected from the group of non volatile flash memory devices consisting of a USB drive, a CD-ROM, an RFID chip, and a magnetic tape strip; said patient encryption set further including a name and password; and
d) a computer device programmed with a patient program capable of operating in response to input of the patient encryption set to interactively connect only with the central server and data storage device through a network, said computer programmed to provide a standard set of informational screens having interactive communication instructions for access to data in and input of data into the central server and data storage device uniquely associated with the patent encryption set only.

2. The system of claim 1 wherein the first and second encryption code instructions are identical.

3. The system of claim 1 wherein the first and second encryption codes comprise distinctive passwords only.

4. The system of claim 1 wherein the first and second encryption codes comprising distinctive names only.

5. The system of claim 1 wherein the first and second encryption codes comprise distinctive names and passwords only.

6. The system of claim 1 wherein the first and second encryption codes comprise unique multiple bit encryption codes.

7. The system if claim 1 wherein the multiple bit hardware device further includes a program instruction set for programming said computer device with said patient program.

8. The system of claim 1 wherein the patient program includes a sort program for searching data stored in said central server and storage device based upon portions of key words and key words.

9. The system of claim 1 further including multiple external input sources of medical data, each separately connectable to the central server and data storage device, each further including a unique encryption code to achieve access to said central server and data storage device.

10. The system of claim 1 further including multiple external input sources of medical data, each separately connectable to the central server and data storage device, each further including the patient encryption set to achieve access to said central server and data storage device.

11. The system of claim 1 including an interactive program in said central server and data storage device for controlling data entry in compliance with a standard medical nomenclature.

12. The system of claim 11 wherein the standard nomenclature comprises a national medical code.

13. The system of claim 1 wherein the remote hardware components of said system are linked by the world wide web.

14. The system of claim 1 wherein the patient encryption set hardware is portable.

15. The system of claim 1 wherein the central server and storage device is programmed to separately store medical data associated uniquely with each of said unique first and second encryption codes.

16. The system of claim 15 wherein said central server and storage device is further programmed to sort the unique medical data associated with each of said first and second encryption codes obtained from diparite sources by a key word code.

17. The system of claim 1 wherein said network is a combination of the world wide web and a separate network.

18. The system of claim 1 including an auxiliary server and data storage device connectable by a network link to the server and date storage of medical record data.

19. The system of claim 1 further including a means to bypass the first encryption code for access to records in said central server and storage device for read only communication therewith.

20. The system of claim 1 including a means to bypass the second encryption code for access to records in said central server and storage device for read only communication therewith.

21. The system of claim 1 including a means to bypass the first or second encryption code for access to records in said central server and storage device for interactive communication therewith.

22. The system of claim 1 including a programming function in said central server and storage device for collating the data associated with each unique patient encryption code.

23. The system of claim 22 further including a programming function for collating said data in accord with a standard medical code.

24. The system of claim 9 including a programming function in said central server and storage device for collating the data from multiple input sources separately for each unique patient encryption code.

25. The system of claim 24 further including a programming function for collating said data in accord with a standard medical code.

26. The system of claim 1 further including a programming function in said central server and data storage device for registering variations of medical data from normalized data.

27. A medical record system comprising, in combination:
a) a central server and data storage device capable of receipt and storage of medical data from multiple external sources, translation of said data into selected formats, transmission of said data and portions thereof in response to internal and external commands for access to said data in response to at least a first and a second encryption code instruction; said first and second encryption code instruction each comprising a unique multiple bit encryption code, a password and a name;
b) at least one external input source of medical data in the form of a standard set of medical terminology, said external source including a means for access through a network to and interactive connection for transmission of data with the central server and storage device upon entry of said first encryption code;
c) a patient encryption set comprised of at least two separate encryption codes compatible but only in combination with said server second encryption code, said patient encryption set including a multiple bit hardware device having a unique encryption code, said device selected from the group of non volatile flash memory devices consisting of a USB drive, a CD-ROM, an RFID chip, and a magnetic tape strip, said patient encryption set further including a name or password code; and
d) a computer device programmed with a patient program capable of operating in response to input of the patient encryption set to interactively connect with the central server and data storage device through a network, said computer programmed to provide a standard set of informational screens having interactive communication instructions for access to data in and input of data into the central server and data storage device uniquely associated with the patent encryption set only.

28. A medical record system comprising, in combination:
a) a central server and data storage device capable of receipt and storage of medical data from multiple external sources, translation of said data into selected formats, transmission of said data and portions thereof in response to internal and external commands for access to said data in response to at least a first and a second encryption code instruction; said first and second encryption code instructions each comprising a unique multiple bit encryption code, a password and a name;
b) at least one external input source of medical data in the form of a standard set of medical terminology, said external source including a means for access through a network to and interactive connection for transmission of data with the central server and storage device upon entry of said first encryption code;
c) a patient encryption set compatible only with said server second encryption code, said patient encryption set including a multiple bit hardware device having a unique encryption code, said patient encryption set further including a name or password code; and
d) a computer device programmed with a patient program capable of operating in response to input of the patient encryption set to interactively connect only with the central server and data storage device through a network, said computer programmed to provide a standard set of informational screens having interactive communication instructions for access to data in and input of data into the central server and data storage device uniquely associated with the patent encryption set only.
